(19) United States
(12) Patent Application Publication
(10) Pub. No.: US 2025/0197304 A1
(43) Pub. Date: Jun. 19, 2025

(54) ORGANIC ASH TEA PRODUCTION FOR IRRIGABLE NITROGEN FERTILIZER

(71) Applicant: Nitricity Inc., Fremont, CA (US)

(72) Inventors: Joshua M. MCENANEY, Fremont, CA (US); Nicolas H. PINKOWSKI, San Francisco, CA (US); John A. SCHWALBE, Fremont, CA (US); Jason CORNEILLE, San Francisco, CA (US); William Fantin, Richmond, CA (US); Ganesh Iyer, Fremont, CA (US); Naveen Dhanapal, Fremont, CA (US)

(21) Appl. No.: 18/983,273

(22) Filed: Dec. 16, 2024

Related U.S. Application Data
(60) Provisional application No. 63/611,015, filed on Dec. 15, 2023.

(51) Int. Cl. C05D 9/00; B01D 47/02; B01D 47/06; B01D 53/14; B01D 53/18; C05G 5/23; F23G 5/08

(52) U.S. Cl. CPC C05D 9/00; B01D 47/02; B01D 47/06; B01D 53/1493; B01D 53/185; C05G 5/23; F23G 5/085; B01D 2252/103; B01D 2257/404; B01D 2258/0283; F23G 2204/201

(57) ABSTRACT

Systems utilizing high temperature combustion generate an organic ash tea that may be used as a fertilizer. A biomaterial is fed to a high-temperature combustion reactor, where the biomaterial and nitrogen gas are burned to fix nitrogen in the burned biomaterial. The biomaterial is then steeped in water, which absorbs the nitrogen compounds and other combustion products. This ash tea may then be used as a fertilizer in agriculture.

### CROSS-REFERENCE TO RELATED APPLICATIONS

This application is related to and claims priority under 35 U.S.C. § 119(e) from U.S. Patent Application No. 63/611,015 filed Dec. 15, 2023, entitled “Organic Ash Water Production for Irrigable Nitrogen Fertilizer,” the entire contents of which is incorporated herein by reference for all purposes.

### TECHNICAL FIELD

Embodiments of the present invention generally relate to a high temperature combustion process, such as a plasma or other high-temperature combustion process, for the burning and aqueous capture of biologically derived materials and the resulting combustion products to create an irrigable organic fertilizer. More specifically, aspects of the present invention relate to a production of organic or nature-based fertilizers where biologically derived materials are burned in a nitrogen-containing plasma and the resulting products are captured in water to make solid ash and liquid irrigable ash water, containing nutrients for growing crops including bio-available nitrogen. The ash water may extract nutrients from the solids to form an “ash tea.”

### BACKGROUND AND INTRODUCTION

Organic and localized crop production has become increasingly popular for a variety of reasons. Unlike much conventional commercial scale farming, organic agriculture avoids or largely reduces the use of synthetic chemical inputs, herbicides, and pesticides, thereby minimizing soil degradation, water pollution, and risks to human health. One of the most pronounced benefits of organic farming is the reduced reliance on chemical pesticides and herbicides. These types of chemicals may be harmful to both human health and the environment, often contaminating water sources and endangering non-target species, such as pollinators and other beneficial insects. However, despite the many advantages of organic farming, it is not without its limitations, particularly concerning the availability of nitrogen fertilizers, an essential nutrient for plant growth.

Nitrogen fertilizer is particularly important because inadequate nitrogen levels can lead to poor crop yields and increased susceptibility to diseases. Organic nitrogen fertilizers derived from plant or animal waste today, have lower nutrient densities compared to synthetic ammonia-based fertilizers. This means that larger quantities may need to be applied to achieve the same level of fertility, leading to higher labor and transportation costs. These fertilizers are also often non-irrigable, meaning that farmers who could otherwise apply them in irrigation streams mid-season cannot with organic practices and products. This is a key disadvantage, because farmers are forced either to overapply non-irrigable fertilizers at the beginning of the season, leading to nitrate runoff as well as methane and nitrous oxide greenhouse gas (GHG) emissions, or to purchase excessively expensive, irrigable organic fertilizer, which raises the prices of organic crops and decreases the adoption of and financial access to organic crops. Some organic fertilizers today come from sodium nitrate mineral ores, but these can damage soil over time due to the salt content, thus their application is limited. Additionally, when considering the origin of the nitrogen in animal waste, a common organic fertilizer, it not only can carry undesirable pathogens to the crops, but it originates from animal feed which is most commonly grown with ammonia-based fertilizer from the synthetic Haber Bosch process, an unsustainable process ultimately responsible for as much as 7% of global GHGs. It is important to address these issues for organic crop production to be truly sustainable.

For these and other reasons, there is a need to develop more efficient, irrigable forms of organic nitrogen fertilizers, with reasonably high nitrogen content. Such fertilizer materials would not only enhance the productivity of organic and climate-smart farming but could also make it more competitive with conventional methods, thereby encouraging more farmers to adopt sustainable agricultural practices. Additionally, many waste biological materials, such as nut shells, crop husks, organic oils, organic extracts, and roots contain substantial nutrients, which could be processed and extracted to provide additional fertilizer value, but are not very useful or valuable without a processing and extraction process due to their decomposition time and often lack of significant nitrogen content.

It is with these observations in mind, among others, that aspects of the present disclosure were conceived.

### SUMMARY

One aspect of the present disclosure is related to a high-temperature combustion reactor, such as a plasma reactor, for generating organic nitrogen ash tea, the reactor comprising gas inlets for controlling the input gas flow and directionality, organic solids inlets, a reactor chamber for burning the organic material and material transfer, an output fluidly connected to a pump for controlling reactor gas flow and pressure, a capture device for collecting the resulting product in water.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a block diagram showing an exemplary conception for producing organic ash.

FIG. 2 depicts an embodiment of a microwave plasma or high-temperature reactor including a biomaterial feed and vortex for burning and transporting ash and combustion products from the plasma chamber to a water-filled organic capture system.

FIG. 3 depicts an embodiment of a plasma reactor torch array fed biomaterials from a mechanical solids conveyor. Ash is primarily captured first and combustion products are captured subsequently in this embodiment of the organic capture system.

FIG. 4 is an embodiment of an arc-based plasma reactor, where solids are fed in above a spread-out arc plasma, in contrast to a plasma torch, such as shown in FIG. 3.

FIG. 5 shows an example of an oxidation chamber for oxidizing the feed stream before capture in an organic capture system.

FIG. 6 is an embodiment showcasing additional details and examples of the present invention.

FIG. 7 is an embodiment of an array of plasma reactors feeding ash and combustion products to a single backend. This embodiment uses a cyclone particle separator to remove the hot ash before processing the combustion products through a fluid organic capture system.

FIG. 8 shows details of an exemplary organic capture system.

FIG. 9 is a flowchart of a method for performing the production of organic ash tea.

FIG. 10 shows a liquid biomaterial with a spray mechanism for input into the high-temperature combustion chamber.

FIG. 11 shows an embodiment including a hot quench spraying device for rapidly cooling and hydrating the ash and combustion product mixture.

FIG. 12 shows an embodiment with a screw feeder, venturi port, and axial-flow input of solid particulates into the combustion chamber.

### DETAILED DESCRIPTION

Before the present invention is disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/ml to 80 mg/ml.” The endpoint may also be based on the variability allowed by an appropriate regulatory body, such as the FDA, USP, etc.

Aspects of the present disclosure involve a system to feed and burn a biomaterial through a high-temperature region, such as a plasma gas region within a combustion chamber, and to capture the resulting ash and combustion products in an organic capture system. Burning of biomaterials may accelerate their degradation and release of nutrients. These nutrients can be used by living bio-organisms for growth, and in the case of agriculture, for crop production. A high temperature burning process (e.g., 1500° C. or greater such as from 2000K-4500K), facilitated by plasma production such as within a plasma chamber, can allow for faster burning of biomaterials and rapid release of these nutrients. Because the reactor allows for a very hot burning process, a large volume of biomaterial may be burned in a shorter period of time. When air or nitrogen gas and oxygen gas are present in a plasma or high temperature flame, oxidized nitrogen species (including nitric oxide and nitrogen dioxide) can be formed as combustion products, which can be reacted and captured as nitric acid or nitrates in water, a bio-available fertilizer. The resulting ash material from the plasma burning process would typically result in an alkaline, high pH solution in water, however the co-production of nitric acid may be neutralized by the alkalinity of the ash, which can result in a nitrogen-rich, pH tunable solution. For example and ss described further herein, increasing the biomaterial feed rate may increase the alkaline content of the ash tea due to the release of alkaline minerals present in the biomaterial, thereby increasing the pH of the ash tea. In another example and similarly, increasing the amount of time the burned biomaterial is steeped in the water may further increase the pH of the ash tea by the release of additional alkaline minerals. Conversely, decreasing the biomaterial feed rate and/or decreasing the steeping time may increase the pH. Thus, feed rate and steep time are two possible tunable parameters that may be used to adjust the pH of the end product.

Just as a lightning plasma fixes nitrogen from air and forest fires release nutrients for new growth, this process borrows from nature to produce the nutrients that crops need. Depending on the biomaterial used and the rate of biomaterial feed, other nutrients such as potassium, phosphorus, calcium, and others add to the value of the resulting ash tea fertilizer. Provided herein is a biomaterial plasma burning and organic capture system with features, materials, and properties to achieve these and other aspects.

As used herein “biomaterial” refers to a material derived from, or produced by, biological organisms like plants, animals, bacteria, fungi and other life forms. The source biomaterial may be organic. In certain embodiments a biomaterial is dry particulate material. Non-limiting examples of appropriate dry biomaterials include almond nut shells, pistachio nut shells, other nut shells, alfalfa, crop husks, corn steep liquor powder, dried corn husks, dried fruit peels, organic dry waste, wood chips, and sawdust. Dry and hard biomaterials are particularly useful as they can be cut, ground, or pulverized into a particulate form, which may flow more easily through the gas connections of the biomaterial plasma burning system as they are processed. Liquid biomaterials may also be used. Non-limiting examples of liquid biomaterials include organic oils, vegetable oils, and organic extracts. Liquid biomaterials have the benefits of requiring less filtration and producing less solid ash buildup in the system.

As used herein, “ash tea” or “nitrogen ash tea” refers to water in which the ash and/or combustion products formed from the burned biomaterial has been absorbed in the water. An ash tea may be formed using the systems and processes described herein; in such embodiments, the term “tea” is not meant to refer to the biomaterial being tea leaves, although tea leaves may be a biomaterial used in the methods of the present disclosure, but rather to refer to the notion of steeping the ash tea for some period of time before applying it as a fertilizer. The ash tea of the present disclosure includes a high concentration of fixed nitrogen that makes it favorable for use as a fertilizer.

As used herein, “burn” and “burning” refers to the process of heating while reacting or oxidizing a nitrogen containing gas or plasma and a biomaterial, to the point where the nitrogen containing gas and/or biomaterial combusts or pyrolyzes. As used herein, “burn” is meant to encompass both combustion (i.e., burning in the presence of oxygen gas) and pyrolysis (i.e., burning in the presence of little or no oxygen gas).

### I. System

The systems of the present disclosure generally comprise a plasma or other high-temperature combustion chamber operable to generate a plasma, and an organic capture system. In one example, the electromagnetic or electrical energy input generates a very high gas or plasma temperature, 1000° C. or greater and preferably 1500° C. or greater within the plasma and an area of the chamber surrounding the plasma. The high temperature provides simultaneous burning of the biomaterial to produce ash and nitrogen fixation.

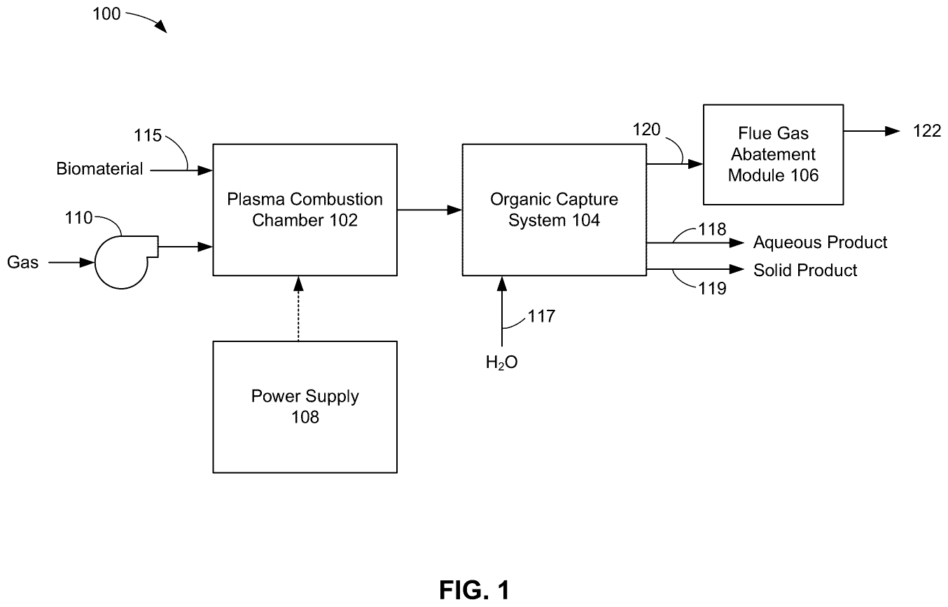

Turning now to the Figures, FIG. 1 shows a block flow diagram, showing an exemplary system 100 for producing aqueous ash fertilizer and solid ash fertilizer. Gas, such as air, nitrogen, and/or oxygen-enriched air is fed through a gas feed 110, such as a pump and gas inlet, to a plasma combustion chamber 102.

In some implementations a biomaterial plasma burning and organic capture system involves a high temperature plasma combustion chamber configured to flow both gas and solid biomaterial particles, or in some cases liquid biomaterial, through a region where a plasma is produced. Various plasma combustion chambers and plasma forms, e.g., arc, radio-frequency or microwave plasma combustion chambers, may be used in the systems of the present disclosure. The plasma combustion chamber includes one or more biomaterial inlets where the biomaterial is fed or otherwise introduced into the plasma combustion chamber to be burned.

In some embodiments, the system of the present disclosure comprises a plasma reactor including a plasma combustion chamber configured to contain an electrode-free plasma reactor which may include a microwave plasma reactor or a radio-frequency plasma reactor. In some embodiments, the system may include a plurality of plasma reactors. An electrode-free plasma system has the advantage of not degrading the electrodes or covering them in ash or soot from the process, which can impede plasma production or sustainability. Microwave and radio-frequency plasmas also offer the advantage of being three dimensional, which, compared to an arc reactor, exposes relatively more gas and biomaterial to the plasma or high-temperature burning region and thus allows for processing of a more significant percentage of the gas and biomaterial that flow through the plasma combustion chamber. In other alternatives, a system of the present disclosure may involve one or more electrode-based plasma reactors. In contrast to electrode-free plasma reactors, electrode-based plasma reactors such as a high-voltage arc plasma, typically have the advantage of being cheaper and simpler than electrode-free plasma power systems. In order to process more of the gas and biomaterial with an arc plasma, the system may include one or more magnets positioned to spread out or direct the plasma to more regions or specific regions where the gas and biomaterials flow through. A soot purging step may be added, where the biomaterial feed is paused and oxygen-containing plasma can oxidize the soot off of the reactor or electrodes.

In an exemplary microwave biomaterial plasma burning system, biomaterial particles are fed into a swirling gas plasma contained in a vortex. In some embodiments, the plasma gas temperatures may reach 1000-4500° C., preferably 1500-3800° C., and more preferably 2500-3800° C. These high temperatures are contained in the plasma vortex, which may partially contain the heat and protect the walls of the plasma combustion chamber. Combustion temperatures of the biomaterial may reach 1000-3000° C. in the plasma chamber as well. Quartz or alumina may be used at the hottest regions or regions necessarily transparent to microwaves, whereas stainless steel, Hastelloy, Inconel, or other nitric acid and NOx compatible materials may be used for the bulk of the plasma reactor chamber.

Returning to FIG. 1, biomaterial is also input into the plasma or high temperature combustion chamber 102 via a biomaterial feed 115. Prior to feeding the biomaterial into the plasma combustion chamber, solid biomaterials may be pulverized using a mechanical pulverizer. Types of pulverizers used may include grinders, burr grinders, blenders, mills, and other pulverizers known in the art. Larger biomaterials may need to go through multiple stages of particle size reduction. Particulate filters of certain mesh sizes may be used to limit the particle sizes used. For example, a 40 mesh or 100 mesh filter may be used so that fine particles passing the mesh sizes are processed in the system and larger particles are captured. In another example, 20 to 200 mesh filters may be used. It should be recognized that other mesh sizes are possible depending on the source material, type and size of plasma chamber, the reaction time (e.g., burn time) in the chamber, type of plasma, and other factors. Fine particulate biomaterials have a high surface area for easy burning through a hot plasma region in some plasma systems; however, larger particle sizes may be easier to separate in subsequent processing steps. Particles may need to be kept dry or actively dried, e.g., with a heated drier, for easy processing and flow through fluidic connections without getting stuck and causing clogs or feed-rate issues in the system. In embodiments using liquid biomaterials, or a combination of liquid and solid biomaterials, the liquid biomaterials may be filtered, dissolved, or mixed with additives to achieve a liquid form and viscosities between 0.1 and 20,000 Centipoise (cP) for spraying. For liquids with viscosities higher than 500 cP, preheating the liquid may decrease viscosity for easier and more consistent spraying into the combustion chamber.

In some implementations, the biomaterial is fed into the plasma combustion chamber via a solids transport mechanism. In certain embodiments, the solid particles are transported to the plasma combustion chamber using a gas input feed to push or pull the solids through. The rate of solid input may be controlled by a venturi mechanism with a pressure differential, by a rotatory valve configured to transport solids, a screw mechanism, by a vibratory mechanism, such as a vibratory trickler or vibratory sieve, calibrated to move particles into the gas feed based on their physical properties (size, weight, friction, etc.), by a mechanical conveyor for dropping biomaterial solids directly into the plasma region, or by some combination of these and related features. Biomaterial particles may be pushed through the system by compressing gas behind the particles in the gas transport pathway, or by pulling them through the system. In some embodiments, pressures above atmospheric will be used throughout the system to promote nitrogen fixation efficiency and NOx capture efficiency.

In some embodiments, a nitrogen-containing gas is fed into the plasma combustion chamber and ignited using a plasma power source. As such, in some examples, the plasma combustion chamber 102 is powered by a power supply 108 electrically connected to the plasma combustion chamber 102, which may power a high voltage generator, a microwave generator, or an RF generator to produce a plasma in the plasma combustion chamber 102. The nitrogen-containing gas may be or include air. In some embodiments, the nitrogen-containing gas may include nitrogen. In some embodiments, an oxygen-containing gas is also fed into the plasma combustion chamber and ignited using the plasma power source. The oxygen-containing gas may include air. The gases may be fed into the plasma chamber via a blower or a compressor.

The biomaterial may be fed to the plasma during the ignition or after the plasma has stabilized such as to not extinguish the plasma by introducing materials that are harder to turn into ions. The high temperature plasma processing of the biomaterials releases combustion products including volatile chemicals and oxidized nitrogen species (referred to herein as NOx), such as NO and NO₂. In preferred implementations, air or nitrogen gas plus oxygen gas are fed into the plasma combustion chamber, which enables combustion of the biomaterial as well as nitrogen fixation and NOx formation, which may be used to produce additional nitrogen fertilizer.

When the biomaterials are burned using a nitrogen- and oxygen-containing plasma, ash and gaseous combustion products are produced. Partial combustion and the presence of water can also result in some liquid combustion products. In some embodiments, water is not introduced independently, but the biomaterials, even though considered dry, nonetheless usually have some internal water and combustion results in the formation of water. Partial combustion or interaction with this water can lead to liquid combustion products. Ash refers to the solid material remaining after the biomaterial particles have passed through the hot plasma region. Typically, the biomaterial ignites in the plasma and releases light and heat energy, and produces ash and other combustion products. The ash typically contains smoke, ash, soot, and carbon, and may also contain calcium in the form of CaO, Ca(CO₃)₂, Ca(OH)₂, and/or other calcium compounds; Potassium in form of K₂O, potash, and/or other potassium compounds; Magnesium in form of MgO and other magnesium compounds; orthophosphates; carbonates; phosphates; nitrates; sulfides/sulfates; aluminum and silicon oxides; Manganese compounds; sodium compounds; unburnt biomaterial particulates or portions of biomaterial particulates which did not significantly burn, and other minor components/oxides such as iron, copper, zinc, etc. The percentage of carbonates and oxides may be dependent upon the conditions in the reactor such as flowrate, carrier gas composition, and temperature. In many embodiments, the combustion products comprise important intermediate gas and/or liquid components, some of which become part of the final product via the organic capture system, and others of which flow through to abatement. For example, the combustion products may contain oxidized nitrogen species (e.g., nitric oxide, nitrogen dioxide, etc.), nitrogen, oxygen, carbon dioxide, carbon monoxide, volatile organic compounds, smoke or very fine particles, bio-oils, and water vapor among other components.

In other implementations, an oxygen poor environment may be used to perform pyrolysis in the plasma system. Pyrolysis is an organic process for making biochar, which is rich in nutrients, without emitting significant CO₂ from the heating process. When pyrolysis is performed in the systems of the present disclosure, those having ordinary skill in the art will appreciate that the products of the pyrolysis are more adequately described as “pyrolysis products” instead of “combustion products”. In addition to the biochar, pyrolysis results in the formation of pyrolysis products such as bio-oil, and syngas. These generally contain less oxidized forms of the materials of the combustion products in which a higher concentration of oxygen is present (e.g., CO instead of CO₂, carbides and carbonates with less oxides in the biochar, chained carbon materials in the bio-oil, etc.). Higher nitrogen content may be embedded into the pyrolysis products in the form of nitrides, nitrates, NOx gas, and other forms of nitrogen, due to the use of the nitrogen-containing plasma. In this case, the biochar and bio-oil or the resulting ash tea may contain bioavailable nitrogen fertilizer, in addition to the soil-enriching properties that these materials already have such as increasing soil carbon and microbiome habitation. As used herein, the term “combustion products” is used throughout, but it is interchangeable with “pyrolysis products” when the plasma reactor operates with little to no oxygen input to support a combustion reaction. To achieve pyrolysis, gases such as nitrogen gas, CH₄, CO₂, CO, or other non-oxygen reactive gases may be used throughout the system. In some embodiments, fine-particulate plasma pyrolysis with an organic capture system of the present disclosure may produce high-value biochar with a rich nutrient profile. With little to no oxygen, more carbon remains in the solid form and fewer volatile oxygenated species like CO₂ are formed.

The systems of the present disclosure include an organic capture module. Referring again to FIG. 1, the plasma combustion chamber 102 is fluidly connected to an organic capture system 104 to capture the combustion products and ash, which may have a water inlet 117, an aqueous product outlet 118, a solid product outlet 119, and a gas outlet 120. The organic capture module is the unit or collection of units designed to input water, which may be referred to herein as process water as its combined with ash and/or other combustion products, to produce tea and other outputs and fertilizers, ash, and other combustion products (e.g., other solids, liquids and gases), and to capture the ash and combustion products for further processing and final product formation. When the ash and combustion products are captured in water, the resulting liquid, which may be an ash tea, may contain significant bio-available nitrogen. Although most embodiments use water to form the ash tea, organic solvents may also be used to extract nutrients from the ash or combustion products. The water may have a slightly basic pH to improve absorption of some gaseous combustion products, such as NOx. The pH and nutrient content of the ash tea can be adjusted by adjusting the ratio of air (and/or other gases) to biomaterial processed and the steeping time of the solid ash in a liquid, typically water but also may be alone or in combination organic solvents. In some embodiments, NO produced in the plasma reacts with oxygen in the system to form NO₂, then NO₂ is captured in the organic capture system in water as nitric acid or nitrate compounds. Those having ordinary skill in the art will appreciate that other acids or nitrate materials may form immediately due to the presence of other materials in the ash tea. The acids are neutralized by the ash tea which typically contains “calcium carbonate equivalent” (CCE) species, including Ca(CO₃)₂ CaO, Ca(OH)₂, Mg(CO₃)₂, MgO, Mg(OH)₂, K(CO₃), KOH, K₂O, and other species, which are basic in solution. Nutrients such as calcium, magnesium, potassium, phosphorus, nitrogen, and micronutrients such as zinc, manganese, iron, copper, molybdenum, and chlorine are able to be captured either through burning and collecting in water or by extraction from the ash.

Steeping time refers to the time allowed for the solid ash to steep in the water (or some other liquid), and in some particular examples the time allowed for the water to extract the CCE and nutrients from the ash, typically before filtering out the solid to produce an irrigable fertilizer, noting the filtered solids may be used for other purposes. The steeping time may be about 1 minute, 10 minutes, 30 minutes, 1 hour, 2 hours, 4 hours, 8 hours, 12 hours, 24 hours, 48 hours, 60 hours, 75 hours, 1 week, 2 weeks, or longer. As discussed with embodiments below, in some examples, active cooling may be involved to enhance NOx absorption. The more biomaterial per air processed, and the longer the steeping time, the more neutral the pH of the resulting nitrogen ash tea. Due to significant protons initially being strongly dissociated by the reaction of NO₂ with water, the pH of the resulting ash tea tends to range from acidic (0) to neutral (7) in this process, despite the presence of the CCE species. This acidic ash tea may be used directly or may be mixed with an alkaline material, micronutrients, or other nutrients to form variations of the product. For example, organic limestone (primarily CaCO₃) may be added to create a calcium-fortified ash tea with a more neutral pH. In another embodiment, alkaline potash (primarily KOH) or phosphate sources may be added to create a neutral to basic ash tea that can provide N, P, and K nutrients.

In some embodiments, the ash tea can have a much higher nitrate content than from low-temperature burning ash tea extractions could have, considering the ratio of nitrogen to other nutrients in the ash due to the fixation of nitrogen in air that takes place during the high-temperature burning process. As an example, a biomaterial with a 1:65 weight ratio of nitrogen to carbon might achieve no more than a 1:10 weight ratio of nitrogen to carbon when using conventional low-temperature burning methods (˜300-1000° C.) with minimal nitrogen fixation. In contrast, the systems discussed herein can generate a high temperature burning of between 1000-4500° C., and preferably 2500-3800° C. As noted above, these high temperatures are contained in the plasma vortex. Within the chamber, due to the heat generated from the plasma, combustion temperatures of the biomaterial may reach 1000-3000° C. By using the systems described herein, the final product may have a 1:5 weight ratio of nitrogen to carbon or higher due to the additional fixation of nitrogen in the plasma reactor.

In some embodiments, addition of the dispersed biomaterial enables ignition of a plasma in the reactor without need for another ignition mechanism. So, the biomaterial itself serves as the ignitor. The biomaterial can provide surfaces where the applied energy of, for example, microwaves rapidly heats up and ignites. Once plasma is ignited, additional energy is absorbed by the plasma, propagating it in the reactor.

The organic capture module may comprise a vessel or a plurality of vessels fluidly connected to the plasma combustion chamber such that the ash and combustion products may be inputted from the plasma combustion chamber to the vessel or the plurality of vessels. Each vessel may include a tank, column, or other vessel filled with water. In some embodiments, the column may include shower or tray NOx absorption columns. Each vessel may include bubble dispersion features to increase the dispersion of gases produced in the plasma combustion chamber. Each vessel may include one or more mesh filters to separate ash particles and other solid particles introduced from the plasma reactor by particle size. Any one of the vessels may include a packing material. Any one of the vessels may include a stirring mechanism to mix the solids in the water. A solids transport mechanism such as a screw conveyor may be used to move the solid materials from the plasma combustion chamber into a vessel and to prevent clogging. The organic capture module may include a variety of sensors for measuring pressure, temperature, level, etc. The vessels may be made of materials capable of handling nitric acid, such as Stainless steel (ex 304 or 316), Inconel, Hastelloy, PVC, PTFE, HDPE, PVDF, fluoroelastomer, and other materials known in the art for handling NOx and nitric acid.

The organic capture module may comprise a solid organic capture submodule and a fluidic organic capture submodule. These submodules may be in a single vessel or in separate vessels. The solid organic capture submodule is configured to capture solid ash produced in the plasma reactor in water. The solid organic capture submodule includes an inlet fluidly connected to the plasma reactor operable to receive the ash and combustion products from the plasma reactor, and a water inlet to receive water for steeping the ash. Ash tea is generated in the solid organic capture submodule when the ash contacts the water. The ash tea is recovered from an aqueous product outlet. The remaining ash is separated from the ash tea, and then the ash is recovered from a solid product outlet, e.g., a solids removal door built into the solid organic capture submodule. Any remaining ash, which may settle on the bottom of capture module, is generally a nitrogen-rich sludge, which may be considered a compost, that is valuable as a soil amendment for farms. The ash sludge may be removed from an access port and door in the lower portion of the submodule. Pre-burned and nitrogen rich compost is relatively ideal to add soil carbon and other nutrients back to the soil at the beginning of growing seasons.

In some embodiments, the first organic capture module or submodule is a hot quench device, configured to receive ash and combustion products at elevated temperatures and quickly cool and hydrate them by spraying a water-containing liquid in the module. This device typically has high liquid flow rates, a heat exchanger to cool the recirculating water, filters to remove the solids before spraying, has a specialized spray nozzle, and is made of materials that can handle hundreds of degrees of gas temperature in the presence of nitric-acid-containing water droplets. As the ash and combustion products are sprayed, the absorption of the ash and combustion products into the water begins prior to introduction into additional organic capture modules. A hot quench device is particularly advantageous to keep the process gas hot until water is introduced, which prevents the buildup of condensable materials in the process piping. In other embodiments, jacketed piping is used to control the ash and combustion product process temperatures on their way to the organic capture module. Gradual cooling and smooth, gradual curves in the process piping may be used to limit ash and condensable material buildup as well. Cool process gas and NO₂ is more readily captured in the organic capture module. Additionally, it may be important to include detachable points for regular maintenance or fluidic inputs and outputs to allow for a water flushing cleaning mechanism in the process piping and process equipment, to prevent buildup.

The combustion products are captured in the fluidic organic capture submodule, where the combustion products produced in the plasma combustion chamber are absorbed in water, thereby generating ash tea comprising nitric acid among other aqueous products. The fluidic organic capture submodule includes a gas inlet fluidly connected to the solid organic capture submodule and/or to the plasma reactor to receive the combustion products and a water inlet for receiving water used to absorb the combustion products. The remaining gas may be recycled or sent to another absorber before being released to the environment. In some embodiments, the remaining gas may be sent to a flue gas abatement module before release into the environment. The aqueous absorbed combustion products include nitrogen compounds useful as organic fertilizers and may be collected for use on their own. In other embodiments, the aqueous absorbed combustion products are combined with the ash tea from the solid organic capture submodule.

One embodiment of the organic capture system involves a single column filled with water and air, and configured with a large port at the bottom for receiving solid, liquid, and gas components of the ash and combustion product stream and an outgas at the top of the column. This column may also be configured with packing material, mid-column bubble dispersion mesh, or a shower mechanism for increasing the gas to liquid interfaces for absorption. Solids and liquids may be separated within this column using their location in the column and filtration, or kept together for further processing. Generally, gases in the column will rise through the water to the top of the column and liquids and solids will sink to the bottom of the column. During this rise and fall, the ash and combustion products are steeped in the water, resulting in the formation of ash tea. The solids may be pumped out near the bottom of the column and filtered to remove the solids from the water. This may occur through a recirculation loop, wherein the filtrate from the solids is reintroduced to the column for additional extraction. The remaining solids form a viscous sludge that may be removed into a separate vessel.

In other embodiments, the organic capture system includes two or more processing vessels. Generally, when a plurality of vessels are included, the plurality of vessels are connected in series and the first vessel is generally used to separate solids from liquids. The first vessel may be partially filled with water and may include a large port in the bottom for receiving the ash and combustion products, capturing the ash and some of the combustion products. This first vessel is a solids organic capture submodule. The residence time of the ash from the plasma combustion chamber may be adjusted to increase or decrease the steeping time, thereby adjusting the pH of the water in the organic capture system and also adjusting the extraction of nutrients from the ash. The first vessel may include a solids outlet, wherein the solid material in the first vessel may be removed by gravity from the bottom of the vessel by e.g., the opening of a valve. The solid material, which includes ash, may be used as a fertilizer product. Gases including combustion products and smoke produced in the plasma combustion chamber may be bubbled through the water in the first vessel. These gases may be collected and provided to a subsequent vessel for additional capture in water or may be scrubbed prior to release to the environment.

A second vessel may also be used for capture of oxidized nitrogen species and other combustion products in water. The second vessel is a fluidic organic capture submodule. The second vessel is fluidly connected to the first vessel in series such that the second vessel is operable to receive gas and water from the first vessel. The gas from the plasma combustion chamber may be introduced to the second vessel to be absorbed by the water. A bubble column or other absorber column is preferably used to maximize absorption of the gases. Fresh water may be introduced to this second vessel, or water from the first vessel which has absorbed nutrients from the solid material may be introduced to the second vessel. The organic capture system may include a plurality of filters to capture fine particulate matter and ensure the irrigability of the water. Generally, the filters may comprise 120 mesh filters up to 500 mesh filters.

In some embodiments, antifoaming agents such as organic soybean oil, waxes, lemon oil, lemons, lemon peels, citrus oils, oil blends, or dimethyl polysiloxane may be added to one or more vessels in the organic capture module to reduce and/or minimize foaming.

The ratio of water to biomaterial may be adjusted to control pH and final composition of the ash tea. The weight ratio of water to biomaterial may range from about 0.1:1 to about 1000:1, such as from about 0.1:1 to about 1:1, about 0.1:1 to about 10:1, about 0.1:1 to about 100:1, about 0.1:1 to about 1000:1, about 1:1 to about 1000:1, about 10:1 to about 1000:1, or about 100:1 to about 1000:1.

In some aspects, a recycle loop may be used to capture more of the gas products (i.e., combustion products, smoke etc.) flowing through the organic capture module before release to air. The recycle loop may be fluidly connected to an outlet of the organic capture module, and more preferably an outlet of the fluidic organic capture submodule, and to the inlet of the organic capture module. In some implementations, a flue gas adsorber or specialized capture system fluidly connected to the organic capture module and designed to capture the remaining levels of uncaptured NOx, SOx, CO, CO₂, or volatile organic compounds (VOCs) may be used before release to air. Examples of VOCs may include aromatic compounds, carbonyls, alcohols, hydrocarbons, and other volatile organic compounds that are released when the biomaterial is burned.

Temperature control of the ash and combustion products after burning in the plasma reactor and in the organic capture module serves to protect the system from high temperatures and to sufficiently cool the gas stream to promote efficient NOx absorption for nitrogen fertilizer production. In some embodiments, after leaving the plasma region, the ash and combustion products are rapidly cooled by heat transfer to the surrounding gas volume and environment. The rapid cooling may be accomplished by including a vortex gas flow to the combustion chamber. The gas vortex surrounds the center hot region of the combustion reactor where temperatures are highest. The gas vortex itself may then be surrounded by a water-jacketed metal reactor body. This embodiment may cool the gas by several hundred to several thousand degrees.

In some additional embodiments, a temperature quenching mechanism may be deployed such as a new fluid stream such as a hot quench device or by transporting an output stream of the ash and combustion products through a heat exchanger configured to allow solids to pass through, for example a large diameter tube surrounded by a corrugated metal tube in water. In some embodiments, the heat exchanger including the surrounding tubing where solids are flowing with gas may include a tube or series of tubes built with smooth, gradually changing surfaces and directions to allow near laminar flow and to avoid the formation of eddy currents and the trapping and buildup of solid materials. Typically, a temperature of about 40° C. or less is preferable for efficient NOx capture as nitrates.

Some embodiments may distinctly separate the ash and combustion product streams to separately obtain an irrigable nitrogen-containing fertilizer separate from the solid ash product and ash tea. This can be useful for lowering the cost of the system components, such as heat exchangers and complex absorber columns, which will otherwise be designed to flow through or input significant solid material. Even in these solid/gas separated cases, the product streams may be re-combined for steeping and product standardization. Solid ash particles may be captured from a gas stream by one of several different mechanisms. For example, a first column partially filled with water may be located below the plasma combustion chamber to capture solids with the water and gravity before allowing the remainder of the gas combustion product stream to proceed with little to no ash particles. A cyclone particle separator may be used with an input lateral flow of ash and combustion products, where the conical shape of the separator forces the gas the spiral downward toward a solids organic capture system. In this case, a gas outlet port is located in the wide top center of the funnel shaped separator, and a smaller inner cyclone of gas with fewer particles is propelled up and out of the separator. The remaining combustion products proceed to other components in the system which may include a heat exchanger and a fluidic organic capture submodule. A gas/solid separator may require cooling via a water-cooled jacket or a solids-compatible heat exchanger due to the high temperature of combustion.

In some embodiments, the solid and fluidic organic capture submodules may be fluidly connected such that the aqueous product stream (i.e., the ash tea) from the solid organic capture submodule and the aqueous product stream from the fluidic organic capture submodule may be collected. In other embodiments, the solid organic capture submodule may be in the same unit or column as the fluidic organic capture submodule, but separated by mesh or a filter so that the solids are kept in different regions of the column. If the solids are significantly separated to make a fluid with little to no solids, gas dispersion frits or bubble dispersion packing may be used above the solids without significant risk of clogging. In this case, fluid shower or tray-based recirculation flows can be used with less maintenance risk. These mechanisms are useful for efficiently absorbing gas, such as NO₂, in the water or ash tea.

The system may include an oxidation chamber to oxidize NO to NO₂ in the combustion products produced in the plasma reactor before being absorbed by water in the organic capture module. The oxidation chamber may be a separate component of the system or may be included in the organic capture module. In some embodiments, the oxidation chamber comprises an inlet fluidly connected to the plasma reactor to receive the ash and combustion products from the plasma reactor, and an outlet fluidly connected to the organic capture module. Alternatively, the oxidation chamber may include an inlet fluidly connected to a solid organic capture submodule to and an outlet fluidly connected to a fluidic organic capture submodule. The oxidation chamber may include a reaction volume to enhance the oxidation of nitrogen species with oxygen, ozone, or heterogeneous catalysis.

Referring again to FIG. 1, the gas outlet 120 may be fluidly connected to a flue gas abatement module 106 to remove one or more of the remaining combustion products before the gas leaves the system through gas outlet 122. The system may include a flue gas abatement module to treat un-captured combustion products and other gases prior to release to the atmosphere. Flue gas abatement processes and systems are generally known to those having ordinary skill in the art. The flue gas abatement module may include a NOx capture unit, a CO₂ sequestration unit, a CO removal unit, a VOC removal unit, or a combination thereof.

The resulting liquid and solid products have specific features which may be valuable as soil additives and/or fertilizers. Both the solid ash product and the irrigable fertilizer are higher in nitrogen content for this high-temperature plasma combustion process than for low temperature flame combustion and water extraction would be for the same biomaterial. The pulverization process and burning of the biomaterial turns the solid product into an excellent, high-value compost material, which can be as easy as soil to spread on farming fields. The filtered liquid product is irrigable, which is currently very rare for organic nitrogen fertilizer products. Both products can be rich in nitrogen, potassium, phosphorous, calcium, magnesium, and micronutrients, depending on the biomaterial chosen.

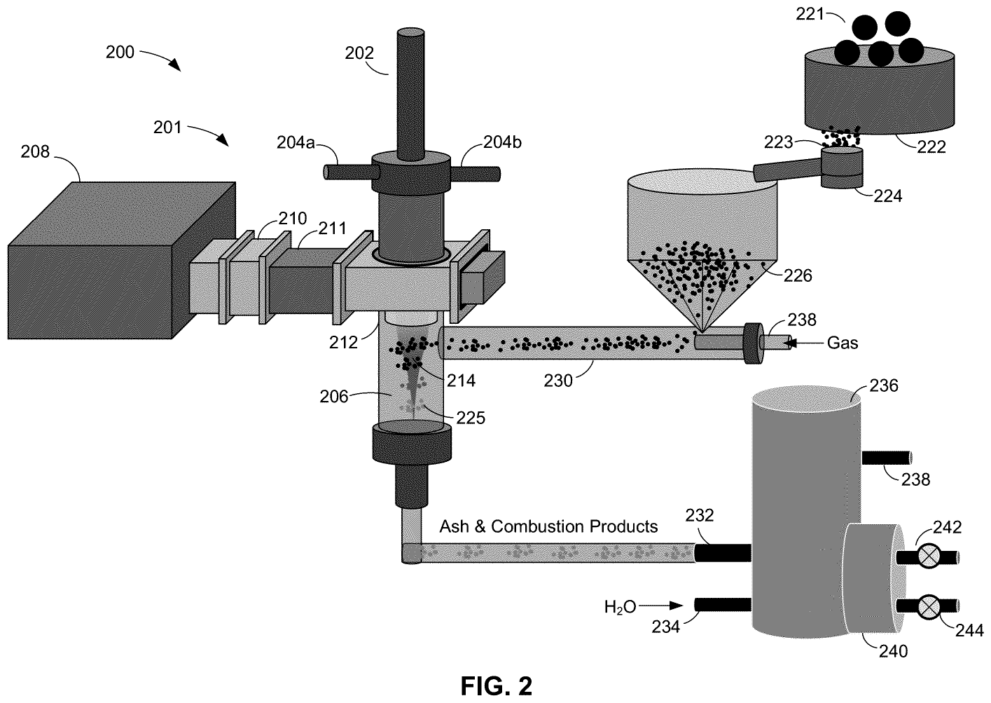

FIG. 2 shows an embodiment of a system 200 of the present disclosure including a microwave plasma reactor 201 including a solid biomaterial feed 230 from a biomaterial reservoir 226 and a vortex chamber 206 for burning and transporting ash and combustion products from the plasma combustion chamber 206 to a water-filled organic capture module 236. In this example, the biomaterial is injected into the high temperature chamber to be burned below where the microwaves are coupled to the chamber, and below where the plasma is ignited. It is also possible to inject a liquid biomaterial in the same location. The liquid biomaterial feed may include a spray nozzle to spray liquid biomaterial into the chamber. The nozzle may be oriented to spray material perpendicular to the chamber, as shown, or may be oriented to spray the liquid biomaterial downward at an angle into the chamber in the direction of the process gas flow flowing down from above and also more along the chamber axis. In one example, the nozzle may also be inset from the chamber wall and not directly in the path of the plasma. In one such example, the plasma wall itself may include one or more apertures that direct the liquid biomaterial into the chamber, with the apertures acting like nozzles.

The microwave generator 208 may be equipped with waveguides for moving microwaves toward the plasma combustion chamber 206. It may also be equipped with automatic or manual tuners 210, such as a 3-stub tuner or sliding tuner for tuning the forward microwave power for ignition or plasma power absorption. The plasma combustion chamber 206 may also be equipped with a circulator 211 for protecting the source from reverse microwave power, a splitter for feeding multiple plasma regimes, a dielectric window for separating the plasma regime from the waveguide, a cooling jacket for keeping the waveguide or generator at a cool operating temperature, and other features to improve safety, efficiency, or operability of the system 200.

The plasma combustion chamber 206 includes a dielectric tube region 212, which is mostly transparent to microwaves. The dielectric tube region 212 may be made from quartz, alumina, or other materials that are capable of containing the plasma and withstanding high temperatures. Gas input ports 204a, 204b are shown at the top of the plasma combustion chamber 206 for inputting one or more process gases, such as air, nitrogen, oxygen, or combinations thereof, to contact an igniter 202 that extends into a portion of the tubular combustion chamber where the gas input ports are positioned, and above where the plasma is ignited and formed within the chamber.

Biomaterial 221 is pulverized by a pulverizer 222. The pulverizer may be a grinder, a burr grinder, a blender, a cutting device, a mill, a crusher, or another pulverizing device known in the art. The pulverized biomaterial 223 may be fed into the chamber in various ways. In the example shown, pulverized biomaterial is fed into a vibratory rate controller 224, such as a vibratory trickler, a vibrating sieve, or a vibrating funnel. Although not shown in FIG. 2, the biomaterial may be filtered with sieve devices between each step before being fed into the system 200. Although shown operably connected to the system at the reservoir (e.g., hopper), the biomaterial may be processed elsewhere and fed into the reservoir by other means.

The biomaterial may be fed into the chamber in various possible ways. In the example illustrated, the pulverized biomaterial 223 is fed through a biomaterial reservoir 226 to gas input feed 238, which blows gas and the pulverized biomaterial 223 into the plasma combustion chamber 206 via a biomaterial inlet 230 wide enough to not get clogged by the pulverized biomaterial. The gas blown through the gas input feed 238 may include nitrogen, oxygen, air, or a combination thereof. In some examples, the gas may include nitrogen and oxygen, with an oxygen content from about 30% to about 50%. The pulverized biomaterial may turn to ash 225 when burned in the plasma combustion chamber 206.

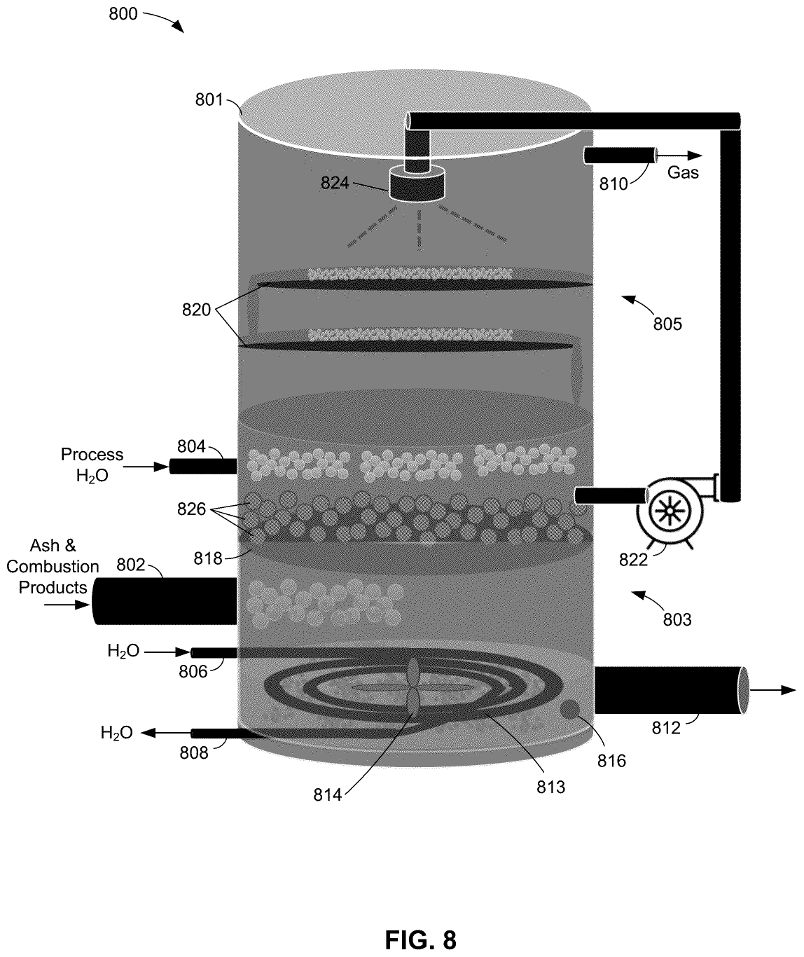

The ash 225 and combustion products are transported to the organic capture module 236. The organic capture module 236 includes a water inlet 234 to introduce water into the organic capture module 236. The organic capture module 236 may include a single vessel configured to capture solid and liquid combustion products in the system 200 depicted in FIG. 2. In the example illustrated, the organic capture module 236 is shown as a column, where the ash 225 and combustion products are input at a point 232 above the bottom of the column. The input location may be adjusted depending on the ash tea liquid processing versus gas capture, and the need to maintain separation between the two, as well as flow rate through the system to accommodate steeping of the ash in the water. In the example shown, the input is near but below the middle of the column height, which allows the ash 225 to fall down into the column below the input and the gaseous products to remain above, depending on the water height. The water in the organic capture module 236 captures solid and fluid products; in particular, NOx is in the gas phase of the ash and combustion products, and is captured by the water. In various possible configurations, the organic capture module 236 include sprayers, nozzles or the like to shower water downward via a recirculation pump, to partition the column and spread out the descent of the water using trays, or to include bubble dispersion components, all for the purpose of maximizing gas absorption into the water. One embodiment of the organic capture module 236 is shown in FIG. 8, described further herein. However, those having skill in the art will appreciate that other configurations are possible and within the scope of the present disclosure.

A gas outlet 238 is located at or near the top of the organic capture module 236, where gaseous products may be sent to another column or to a flue gas abatement module. A separator 240 is shown in a sidewall at the bottom of the organic capture module 236 which may comprise a series of mesh filters for selectively allowing aqueous product out of an aqueous product outlet 242 and solid product out of a solid product outlet 244. In the arrangement shown, the solids outlet 244 is positioned above the aqueous outlet 242. A screw feeder, internal or external to the organic capture module 236, may be used to squeegee the solids and maximize the aqueous product recovery and general separation.

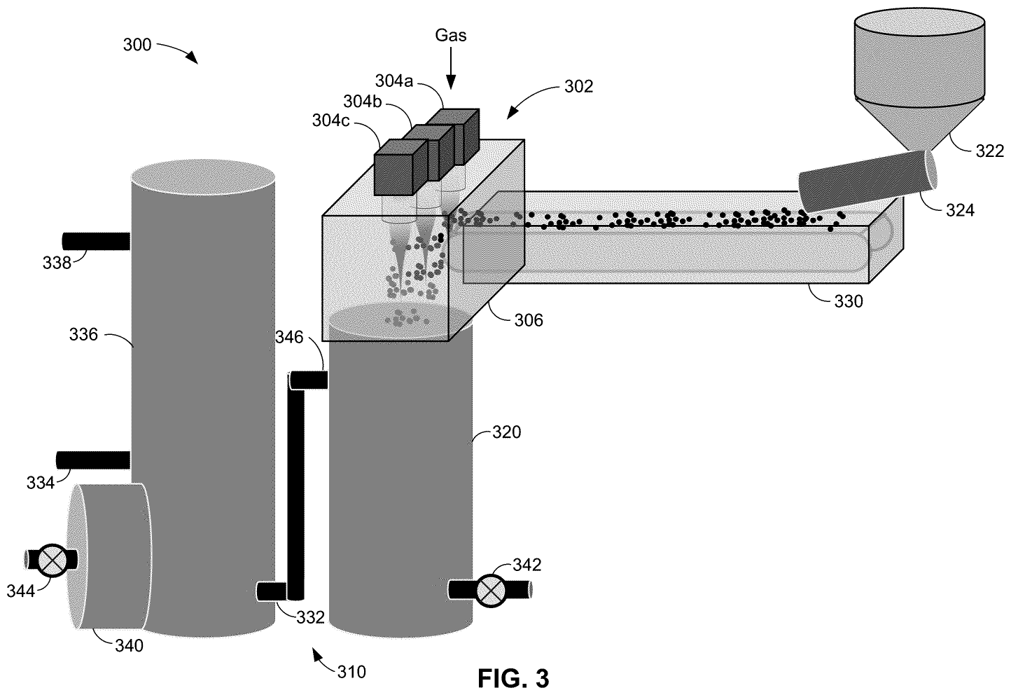

FIG. 3 shows a system 300 of the present disclosure including a plasma reactor torch array 302. Biomaterial is fed to the plasma reactor, which may come from a biomaterial reservoir 322 via a screw feeder 324 to a solids conveyor 330. The solids conveyor 330 carries the biomaterial to the plasma combustion chamber 306. Another embodiment includes a pipe (or pipes) coupled to an inlet (or inlets) of the chamber where pulverized biomaterial may be fed into the chamber with positive pressure as described with respect to FIG. 2.

A plurality, which may be two or more or three as shown, of plasma torches 304a, 304b, 304c burn the biomaterial in the plasma combustion chamber 306 to produce ash. The organic capture module 310 includes a first vessel 320 and a second vessel 336. The first vessel is positioned below the plasma chamber, and ash is gravity fed into the chamber. If positive pressure is in the chamber, then the pressure may assist the gravity feed. Additionally, the torches may be angled and positioned further below the solids input such that particles may fall through the high-temperature region of the torch without exposing the solids conveyor to high temperatures, which could otherwise damage the conveyor.

Ash is primarily captured in the first vessel 320 of the organic capture module 310 and fluidic combustion products are captured subsequently in the second vessel 336. The separation of the solid and fluid organic capture subunits may be advantageous to simplify solid and gas processing. Solids may be captured early, in the first vessel, to prevent clogging of downstream gas handling components. Gravity and filters may be used to move and hold more of the solid material in the first vessel 320, which is equipped with a solid or aqueous ash product output port 342 toward but not at the bottom of the first vessel, and a fluidic connection to the second vessel 336. Larger ash particles are captured in the first vessel 320, and combustion products continue to the second vessel 336 via a fluid product inlet 332. The outlet 346, in the first vessel 320, is positioned toward the top of the first vessel such that ash may settle in water and steep in the first vessel below the outlet, and the outlet may carry combustion products to the second vessel. However, when most of the solids are removed in the first vessel 320, the second vessel 336 may use more gas dispersion devices (e.g., showers, trays, bubble dispersion), with fewer clogging and maintenance cycles. The second vessel 336 is equipped with a water inlet 334. A filter 340 separates remaining solids in the fluid stream, creating an aqueous product stream 344. Either one of the first vessel 320 and the second vessel 336 may be equipped with a solids removal door or tray for easy access into the bottom of the vessels to remove solid ash products that collect in the bottom of the vessels. A gas outlet 338 is located at the top of the second vessel 336, remaining gas may be sent to another column or to a flue gas abatement module.

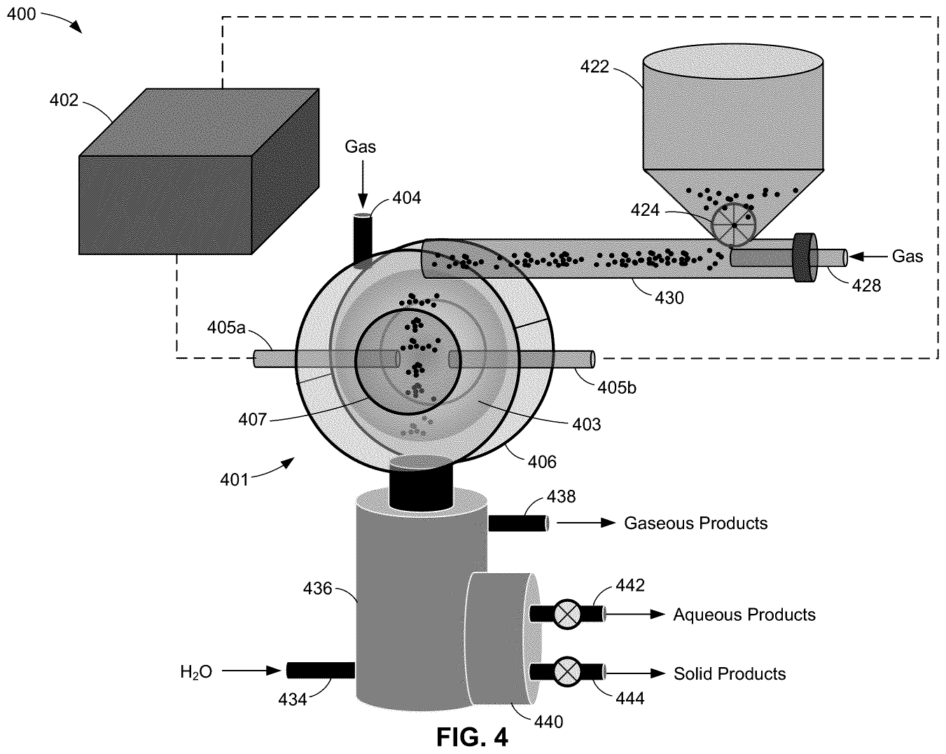

FIG. 4 shows a system 400 of the present disclosure including an arc-based plasma reactor 401, where biomaterial solids are fed into the reactor above a spread-out arc plasma rather than into and through a plasma torch, or burned in a chamber heated from a plasma torch. A high voltage arc plasma is generated between two electrodes 405a, 405b contained in the plasma combustion chamber 406. Magnets 407 (permanent or electric) may be used to interact with the charged species in the plasma, which can direct the charged species to spread out by the magnetic forces acting upon them. This results in the plasma region to spread out, creating a wider region of the hot plasma zone and gas and solids processing than would be possible with an arc alone.

In this embodiment, solids are delivered through the use of a rotary conveyor 424 combined with a gas input feed 428. Gravity and gas flow push the biomaterial through a smooth pipe 430 into the plasma combustion chamber 406 via a biomaterial inlet to the plasma chamber to direct the biomaterial into the plasma region and through the plasma, and then the ash from the biomaterial falls down into the organic capture module 436, which is positioned directly below the plasma combustion chamber 406. The organic capture module 436 includes a water inlet 434 to introduce water into the organic capture module 436. The organic capture module 436 includes a single vessel configured to capture solid and liquid combustion products in the system 400 depicted in FIG. 4. The water in the organic capture module 436 captures solid and fluid products; in particular, NOx is in the gas phase of the ash and is captured by the water. A gas outlet 438 is located at the top of the organic capture module 436, where gaseous products may be sent to another column or to a flue gas abatement module. A separator 440 is shown at the bottom of the organic capture module 436 which may comprise a series of mesh filters for selectively allowing aqueous product out of an aqueous product outlet 442 and solid product out of a solid product outlet 444.

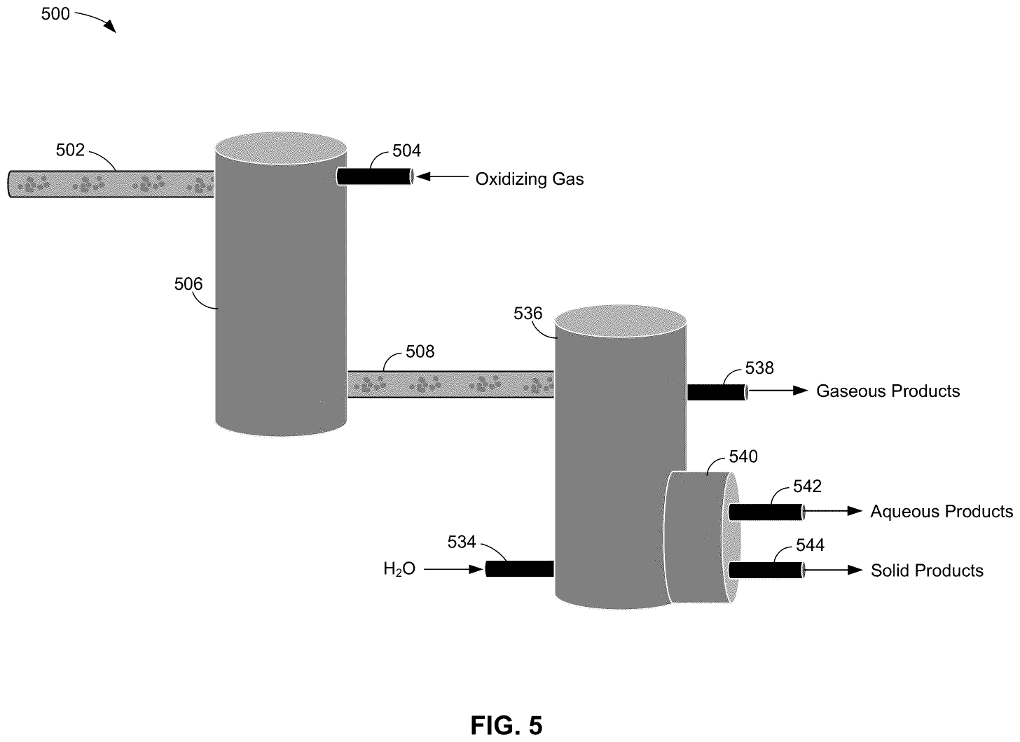

FIG. 5 shows a system 500 of the present disclosure including an oxidation chamber 506 for oxidizing the ash and combustion products 502 from after plasma processing and before capture in an organic capture module 536, which system may be used in various embodiments described herein. This oxidation chamber 506 may include an oxidizing gas input 504, the oxidizing gas including, e.g., oxygen or ozone to convert NO to NO₂ for easier absorption in water. The oxidation chamber may also be used to collect some or all of the ash before the remainder of the combustion products are sent to the organic capture module 536. The oxidized ash and combustion products 508 are then transferred to the organic capture module 536. The organic capture module 536 includes a water inlet 534 to introduce water into the organic capture module 536. A gas outlet 538 is located at the top of the organic capture module 536, where gaseous products may be sent to another column or to a flue gas abatement module. A separator 540 is shown at the bottom of the organic capture module 536 which may comprise a series of mesh filters for selectively allowing aqueous product out of an aqueous product outlet 542 and solid product out of a solid product outlet 544.

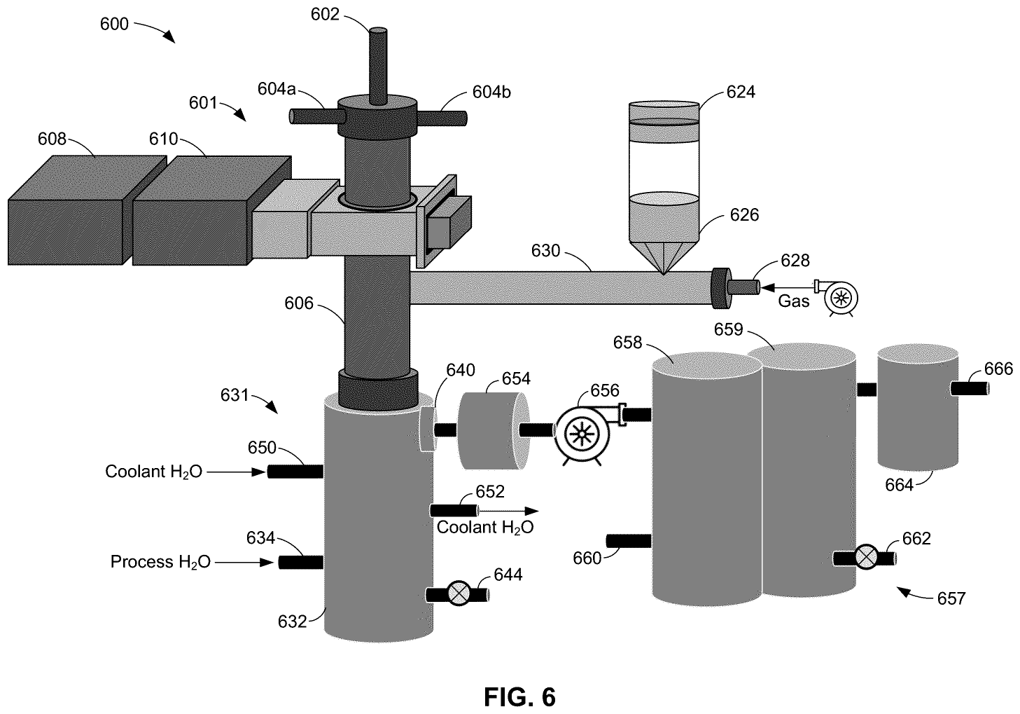

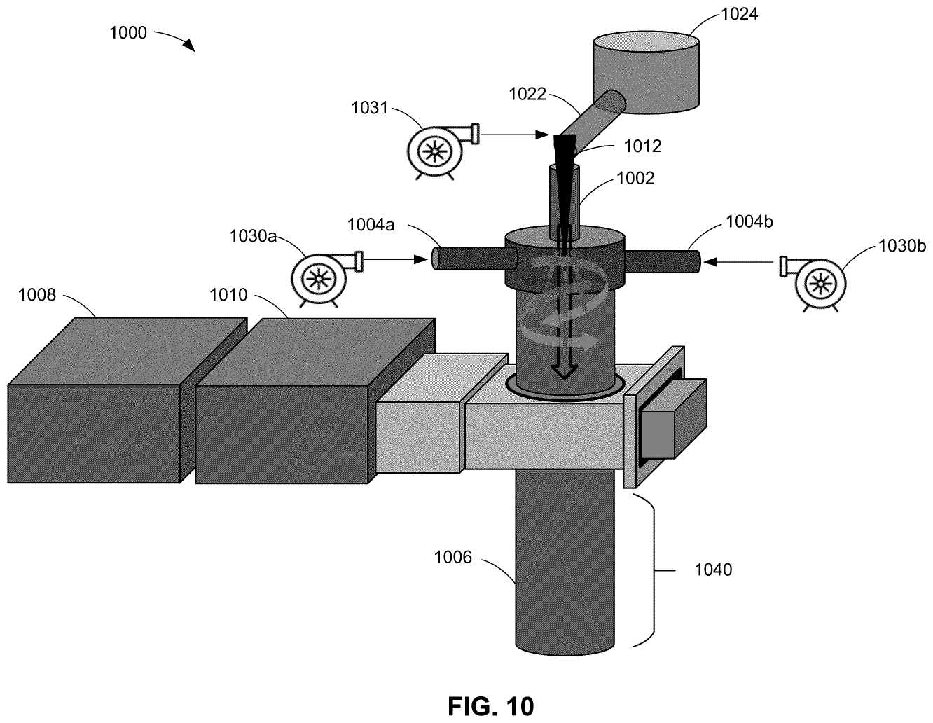

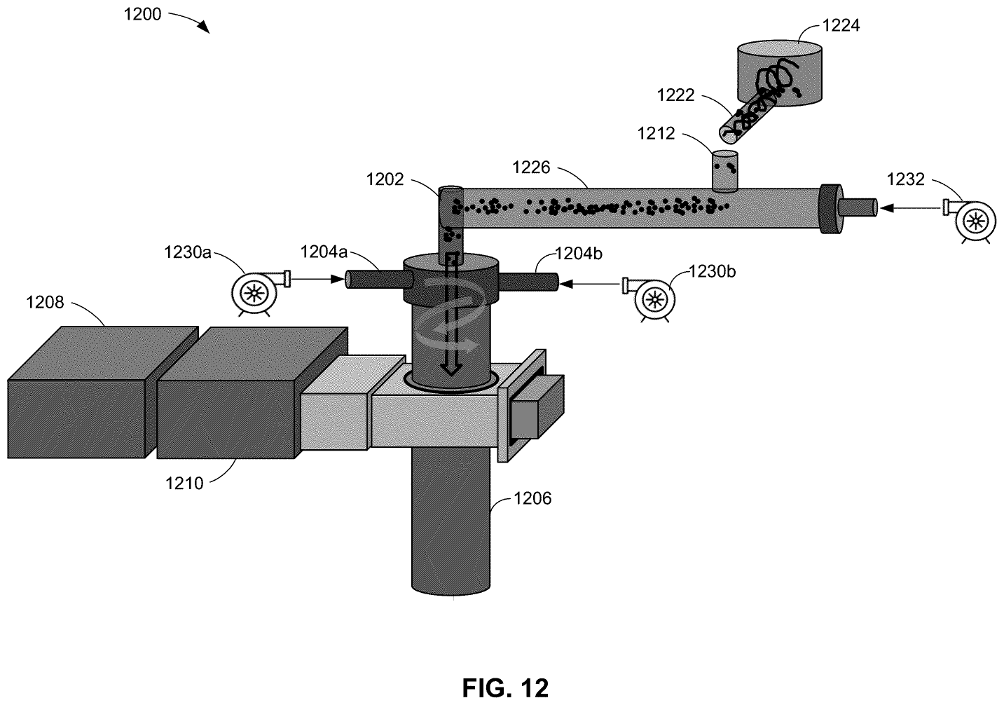

FIG. 6 shows another embodiment of a system 600 of the present disclosure including a microwave plasma reactor 601 designed with a biomaterial reservoir 626 and vortex chamber 606 for burning and transporting ash and combustion products from the plasma combustion chamber 606. A vibratory sieve 624 controls the particle size of the biomaterial provided to the biomaterial reservoir 626. Gas input feed 628 blows gas and the biomaterial into the plasma combustion chamber 606 via a biomaterial inlet 630 wide enough to not get clogged by the biomaterial. Gas input ports 604a, 604b are shown at the top of the plasma combustion chamber 606 for inputting one or more process gases, such as nitrogen, oxygen, or a combination thereof, to contact an igniter 602, which may extend into and retract from the chamber and to the region where the microwaves are directed into the chamber via the waveguide, creating a surface for rapid heating and plasma ignition. Gas input ports 604a, 604b may be oriented to create a vortex flow path of gas, as depicted in more detail in FIGS. 10 and 12. A power supply 608 is electrically connected to the microwave generator 610 to provide power to the microwave generator 610.

A solid organic capture module 631 includes a first vessel 632 located below the plasma combustion chamber 606 to use gravity to assist with solids capture in the first vessel. The first vessel 632 also includes a volume above the water level in the first vessel which acts as an oxidation chamber. The first vessel 632 also includes an inlet 634 for receiving process water to capture the solids as ash tea. The first vessel 632 also includes a coolant inlet 650 to introduce water into a water-cooled jacket to cool the first vessel and optionally to capture the waste heat from the plasma combustion chamber 606. The coolant water exits the water-cooled jacket through a coolant outlet 652. The coolant outlet 652 may be fluidly connected to a recirculating chiller or a cooling tower to cool the coolant water. The first vessel 632 includes an aqueous product outlet 644 to recover ash tea. The aqueous product outlet 644 may optionally include a filter to remove remaining solids from the ash tea prior to storage or shipping. In some embodiments, this water-cooled jacket may be an internal coil or set of tubes for cooling water to flow through. A filter 640 prevents some or all of the solids from proceeding downstream. A heat exchanger 654 is then used to cool the combustion product stream before absorption in a fluid organic capture system. A pump 656 pressurizes the combustion product stream before it enters the fluidic organic capture module 657. and the fluidic organic capture module 657 includes a second vessel 658 and a third vessel 659, each of which have inlets and outlets as necessary for the transfer of water, recirculation of liquid or gas, or output of the ash tea products. As shown in FIG. 6, the second vessel 658 includes a process water inlet 660. The third vessel 659 includes an aqueous product outlet 662. Remaining gas is sent to a flue gas abatement module 664 for further removal of combustion components before outgassing through gas outlet 666.

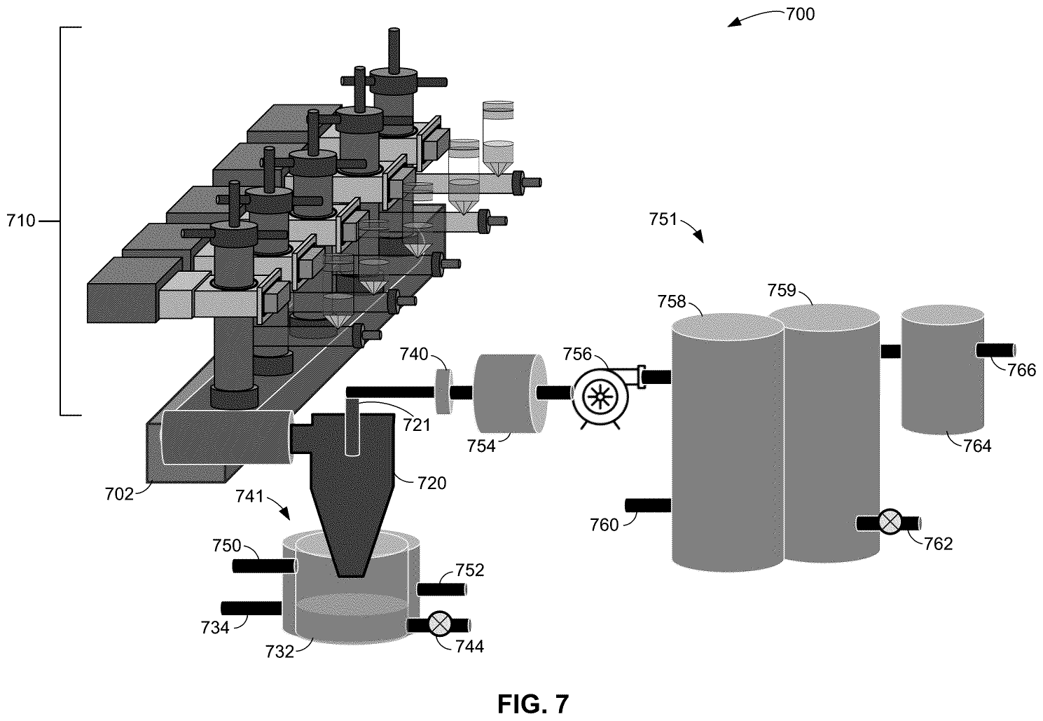

FIG. 7 shows a system 700 of the present disclosure including an array 710 of plasma reactors feeding ash and combustion products to a single backend. This embodiment includes a water-cooled bath 702 for the plasma combustion chambers to release heat into. Removing heat (from high plasma temperatures to a few hundred degrees) here protect the plasma reactors and downstream system components from overheating, which can cause warping, cracking, or melting. This heat may be repurposed for other uses including generating electrical energy or for process heat. A cyclone particle separator 720 separates the hot ash from the combustion products before processing the combustion products in a fluidic organic capture module 751 and processing the solid ash in a solid organic capture module 741. The solid organic capture module includes a first vessel 732 that includes a water-cooling jacket. The first vessel 732 also includes an inlet 734 for receiving process water to capture the solids as ash tea. The first vessel 732 also includes a coolant inlet 750 to introduce water into a water-cooled jacket to capture the waste heat from the plasma combustion chamber 706. The coolant water exits the water-cooled jacket through a coolant outlet 752. In some embodiments, this water-cooled jacket may be an internal coil or set of tubes for cooling water to flow through. The first vessel 732 includes an aqueous product outlet 744 to recover ash tea. The cyclone particle separator 720 has a large outer diameter and gas input directed to vortex gas down toward the solid organic capture module 741, which may be filled with water to help trap the solids and begin making ash tea. The cyclone particle separator may have a smaller-diameter gas outlet 721 located within the conical outer unit. This configuration makes it more difficult for the solids to leave with the fluid stream, thus creating a trap and separation mechanism. An optional filter 740 may be included to prevent some or all of the solids from proceeding downstream. A heat exchanger 754 cools the stream further (preferably down to 40° C. or less) to improve gas absorption efficiency. A blower or gas compressor 756 blows the combustion products into the fluidic organic capture module 751, which includes a second vessel 758 and a third vessel 759. Blower or gas compressor 756 may be a liquid ring compressor, hydraulic compressor, or other compressor with minimal solid on solid contact in its mechanism. Blower or gas compressor 756 is designed to handle a solid particulate load, and is preferably made from a corrosion-resistant material such as stainless steel. The second vessel 758 includes a process water inlet 760. The third vessel 759 includes an aqueous product outlet 762. Remaining gas is sent to a flue gas abatement module 764 for further removal of combustion components before outgassing through gas outlet 766.

FIG. 8 shows an example organic capture module 800 of the present disclosure. In this organic capture module 800, a column 801 is separated by a filter 818 into a solid organic capture submodule 803 below the filter 818 and a fluidic organic capture submodule 805 above the filter 818. Combustion products enter the organic capture module 800 via an inlet 802. Another embodiment of inlet 802 may extend into the center of the tank and elbow downward to release the stream of gas, ash, and other combustion products. Gas bubbles move upward while solids are mostly kept below the filter 818. A constant water level may be maintained in the column 801 by pumping in process water or ash tea from another organic capture module into the column when the water level drops below a predetermined level. Process water is input into the column 801 via inlet 804. Water recirculation allows the water to be sprayed and cascaded down from a shower 824. Water is recirculated via a pump 822. The recirculated water includes ash tea formed in the organic capture module 800. In some embodiments, solid ash particles may be filtered from the water prior to recirculation. Bubbles are dispersed by bubble dispersion packing material 826 and gas-permeable trays 820 to increase gas fluid surface interaction for increased absorption of combustion products. An agitator 814 such as a propeller or screw mechanism may be used in the solids capture area to mechanically move the solids around to increase nutrient absorption into the liquid or to prevent caking of the solids. A solids removal door and tray 816 may be used for batch mode removal of the solids or for maintenance cycles. An interior coil 813 or cooling jacket for delivering coolant water and cooling down the fluids, solids, and column materials may be used to safely remove heat, protect materials, and increase absorption efficiency. Coolant water is input into the interior coil 813 via a coolant water inlet 806 and is removed via a coolant water outlet 808. Ash tea is recovered through an aqueous product outlet 812. Gas is released through gas outlet 810, which may be sent to an absorber for additional processing or to a flue gas abatement module before release to the environment.

FIG. 10 shows a system 1000 in which a liquid biomaterial may be added to the high temperature combustion chamber 1006. A liquid biomaterial reservoir 1024 may be used to store the liquid biomaterial prior to combustion. This reservoir may be enclosed and configured with input and output mechanisms and pumps for filling and transporting the liquid biomaterial. A liquid biomaterial spray nozzle 1012 may be used to disperse the liquid biomaterial into the gas stream of the plasma or high temperature combustion chamber 1006. In certain embodiments, axial and vortex flows may be present. The axial flow is created by pumping air using air pump 1032 through an axial flow port 1002. The vortex flow is created by pumping gas using gas pump 1030a and gas pump 1030b through vortex flow port 1004a and vortex flow port 1004b, respectively. The biomaterial may be dispersed using the gas stream of the flow input 1022 into the spray nozzle 1012 to create a higher dispersion or aerosolization effect for the resulting liquid droplets into the broader gas stream. An independent swirling vortex gas stream may help to contain the droplets near the center of the flow path and away from the combustion chamber 1006 walls, which could otherwise deposit on the walls and cause uneven heating and failure in some cases. The liquid biomaterial is burned in the high temperature combustion chamber 1006. As shown in FIG. 10, the reactor includes a power supply 1008 and a microwave generator 1010. In some embodiments, the liquid biomaterial input is located after the energy input and plasma ignition location of the reactor, such as along area 1040, such that this aforementioned deposition and energy absorption is further mitigated. In this case the reactor piping may be oriented so that the biomaterial spray flows in the general direction of the axial flow port 1002. “After” is used here to refer to the process flow direction, with the process flow initiating at the top in the orientation shown, where input gas is spun into a vortex and then ignited where the microwaves enter the chamber to form a plasma and the liquid biomaterial is sprayed toward the plasma after its ignition.

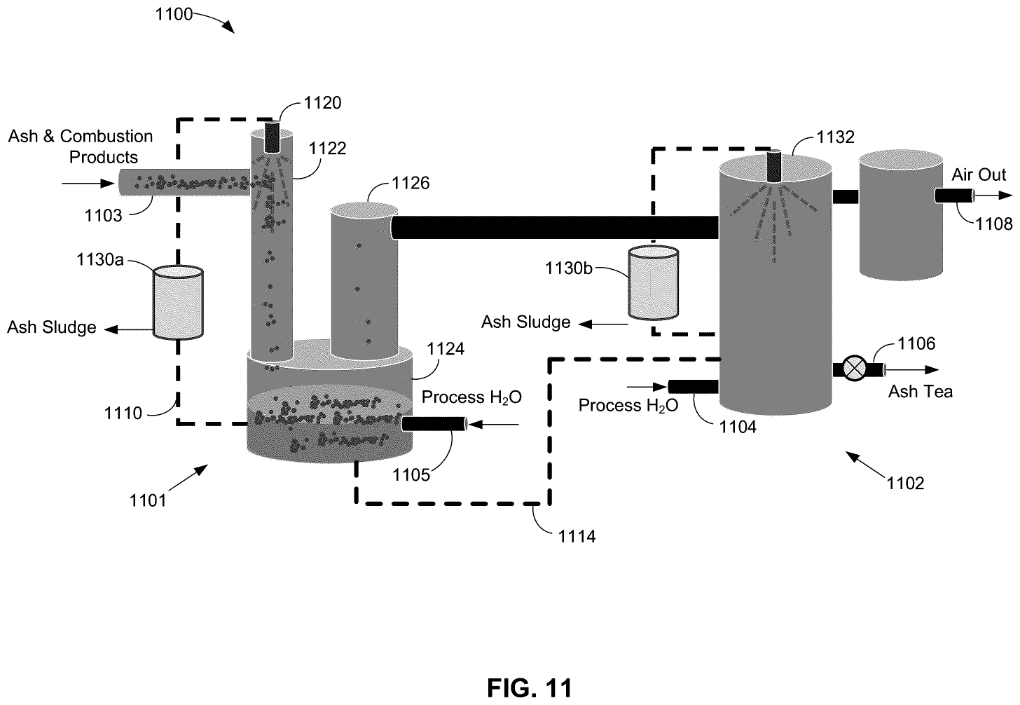

FIG. 11 shows a system 1100 that includes a first organic capture module or submodule 1101 and a second organic capture module or submodule 1102. The first organic capture module or submodule 1124 is a hot quench device configured to receive ash and combustion products from inlet 1103 at elevated temperatures and quickly cool and hydrate the ash and combustion products. This is accomplished by blowing the ash and combustion products through tower 1122 and spraying water from spray nozzle 1120 over the ash and combustion products. This configuration is particularly advantageous to keep the process gas hot until water is introduced, which prevents the buildup of condensable materials in the process piping.

In some embodiments, the ash and combustion products are kept at a temperature above 200° C. or above 300° C. (e.g. 250-500° C.) in the piping leading from the high temperature combustion chamber on the path to the first organic capture module or submodule 1101. Because of the high temperatures and presence of nitric acid in the sprayed combustion products, these components are made from stainless steel, zirconia alloys, niobia alloys, and other materials capable of withstanding high temperature and corrosion. The spray nozzle 1120 is designed to spray water into the narrow tower 1122 that receives the ash and combustion products stream near the top. The spray nozzle may produce slow velocity spray streams with symmetrical velocities, or a wand wide spray to self-clean the tower. The lower temperature water is generally sprayed throughout the tower 1122 and onto the walls of the tower 1122 such that the hot combustion products are doused in water and the tower 1122 self-cleans, washing the residue down into a liquid reservoir 1124 at the bottom of the device. Excess water from the spraying is collected in the first organic capture module or submodule 1101. The water may be recirculated to the spray nozzle 1120 for reuse. The water may pass through a particulate filtration module 1130a prior to spraying to remove solids captured in the water.

After the spray down of the hot quench device, the resulting gas stream has a lower concentration of solids and combustion products and flows through an output tower 1126, which is fluidly connected to the second organic capture module or submodule 1102. The second organic capture module or submodule 1102 may be similar to the organic capture module depicted in FIG. 8, or to other organic capture modules or submodules described herein.

The process water for the first organic capture module or submodule 1101 is supplied from a process water input 1105 and is recirculated in an independent pumped recirculation line 1110 from the liquid reservoir 1124 at the bottom, through a particulate filtration system 1130a which may include a heat exchanger (not shown), and into the spray nozzle 1120 to douse the incoming ash and combustion products from inlet 1103. In the particulate filtration system 1130a, filters such as mesh filters, bag filters, or other filters may be used. The filtered ash (also referred to as an ash sludge) may be manually removed or flushed out with a byproduct removal flush line. The ash sludge includes a high concentration

A similar particulate filtration system with pumps and heat exchangers may be used for each organic capture system module, as shown with respect to the particulate filtration system 1130b in the second organic capture module or submodule 1102.

As shown in FIG. 11, the first organic capture module or submodule 1101 and the second organic capture module or submodule 1102 may be fluidly connected to each other through line 1114 such that new process water may be input to one module and product may be removed from one module and input to another module for continuous operation. Transfer of the liquid from one organic capture module to another may be controlled with a valve, and may depend on the concentration of ash and combustion products in the water or based on the level of product in the organic capture module. The ash tea is collected from output port 1106; however, in some embodiments, ash tea may also be collected from an output port on the liquid reservoir (not pictured).

Turning now to FIG. 12, the system 1200 may be adapted for combustion of small-particle biomaterials (also referred to as particulates). The small-particle biomaterials may be input into the axial flow port 1202 of the plasma or high temperature combustion chamber 1206. In the system 1200 shown, the plasma or high temperature combustion chamber 1206 is connected to a power supply 1208 and a microwave generator 1210. A biomaterial reservoir 1224 equipped with a particulate agitator designed to keep the biomaterials loose with minimal air gaps are provided to the plasma or high temperature combustion chamber 1206 via a screw feeder 1222. The screw feeder 1222 may vary in size or speed to input more or less biomaterial into a gas input stream 1226. From the output of the screw feeder 1222, a venturi port 1212 may be located under the screw feeder 1222 to receive the biomaterial and allow input into the gas input stream 1226. A pump 1232 blows gas, such as air, nitrogen gas, oxygen gas, or a combination thereof, through the gas input stream. The relative pressure and flow rate of the gas input stream 1226 are configured to create a venturi effect, locally pulling the biomaterial particles into the stream at the venturi port 1212. From here, in certain embodiments, the biomaterial particles may flow into an axial flow port 1202 of the plasma or high temperature combustion chamber 1206. A surrounding vortex stream supplied by a pump 1230a and 1230b blowing gas through vortex flow port 1230a and vortex flow port 1230b, respectively, may be used to surround the axial flow containing the biomaterial particles with swirling gas. Upon biomaterial particle or plasma ignition, the biomaterial particles are burned at a high temperature with concurrent nitrogen fixation. The swirling gas may also help to prevent particulates and residue from depositing onto the combustion chamber walls, which could result in uneven heating and failure. Biomaterial particles may additionally or alternatively be introduced to the plasma or high temperature combustion chamber 1206 via the vortex flow ports 1204a, 1204b, which may result in partial combustion and a lower temperature experienced by the biomaterial. This may be useful for extracting certain materials into the ash tea, while leaving others for the solid biomaterial byproduct. The solid ash and other combustion products leaving the plasma or high temperature combustion chamber 1206 are then transported in process piping to an organic capture system.

### II. Processes

Further provided herein are processes for producing an ash tea composition useful as an irrigable fertilizer. The process may be performed by the systems described above in Section I, and combinations of such systems. The process generally includes burning a biomaterial in a plasma or high temperature combustion reactor to form ash and combustion products, and then steeping the ash in water to form ash tea. The plasma is generated from a gas comprising nitrogen, or a mixture of nitrogen and oxygen. In some embodiments, the gas consists of nitrogen. The plasma reactor may be any plasma reactor described above in Section I, as well as other possible forms of plasma reactors modified to include a biomaterial inlet. The biomaterial may be any biomaterial described above in Section I, as well as other forms of biomaterials. The steeping step may be accomplished in an organic capture module, and in some specific examples in a solid organic capture submodule, various examples of which are described above in Section I.

The plasma or high-temperature gas region itself may have a temperature from about 1000° C. to about 4500° C., such as from about 1000° C. to about 1500° C., about 1000° C. to about 2000° C., about 1000° C. to about 2500° C., about 1000° C. to about 3000° C., about 1000° C. to about 3500° C., about 1000° C. to about 4000° C., about 1000° C. to about 4500° C., about 1500° C. to about 4500° C., about 2000° C. to about 4500° C., about 2500° C. to about 4500° C., about 3000° C. to about 4500° C., about 3500° C. to about 4500° C., about 4000° C. to about 4500° C., about 2000° C. to about 4000° C., about 2500° C. to about 4000° C., or about 2000° C. to about 3000° C. Preferably, the plasma has a temperature from about 2500° C. to about 3800° C.

As the biomaterial burns, it may reach a temperature from about 1000° C. to about 3000° C. in the plasma reactor, such as from about 1000° C. to about 1500° C., about 1000° C., to about 2000° C., about 1000° C. to about 2500° C., about 1000° C. to about 3000° C., about 1500° C. to about 2000° C., about 1500° C. to about 2500° C., about 1500° C. to about 3000° C., about 2000° C. to about 2500° C., about 2000° C. to about 3000° C., or about 2500° C. to about 3000° C.

The steeping step may vary in duration to extract additional or fewer nutrients from the ash, depending on the desired final product. The steeping step may be instantaneous (i.e., the ash is steeped in the water very briefly before being filtered), or the steeping step may have an extended duration. In some embodiments, the steeping time may be about 1 minute, 10 minutes, 30 minutes, 1 hour, 2 hours, 4 hours, 8 hours, 12 hours, 24 hours, 48 hours, 60 hours, 75 hours, or longer.

The steeping step may comprise agitating or mixing the ash and the water to increase the rate of nutrient extraction from the ash. This may be accomplished with an agitator such as a propeller or screw mechanism, or other devices known in the art.

The process may include absorbing the combustion products in water. The absorbing is accomplished by contacting the combustion products with water. The absorbing may be accomplished in an organic capture module, and more specifically in a fluidic organic capture submodule, examples of which are described above in Section I.

The process may include cooling the combustion products and the ash prior to steeping the ash in water or prior to absorbing the combustion products in water. The cooling may be accomplished using a heat exchanger, examples of which are described above in Section I. The combustion products and ash may be cooled to a temperature of about 40° C. or less.

The process may include reducing the particle size of the biomaterial prior to burning the biomaterial. The particle size reduction may be accomplished by using grinders, burr grinders, blenders, mills, and other pulverizers known in the art. The pulverized biomaterial may have an average particle size from about 1 micron to about 5 centimeters. Preferably, the average particle size is from about 10 to about 200 microns. The biomaterial or the pulverized biomaterial may be filtered to exclude large particles. The filter may include a 20 to 200 mesh filter, such as a 40 mesh filter or a 100 mesh filter. The process may include drying the biomaterial or the pulverized biomaterial.

The process may include separating the ash from the ash tea after the ash has steeped in the water. The separating may be accomplished using a filter or other separator examples of which are described above in Section I.

The process may include separating the combustion products from the ash prior to steeping the ash in the water. This may be accomplished using a cyclone particle separator may be used with an input lateral flow of ash and combustion products, where the conical shape of the separator forces the gas the spiral downward toward a solids organic capture system. In this case, a gas outlet port is located in the wide top center of the funnel shaped separator, and a smaller inner cyclone of gas with fewer particles is propelled up and out of the separator.

The process may include oxidizing the ash and the combustion products in an oxidizing chamber prior to steeping the ash in the water. The oxidizing chamber may be any oxidizing chamber examples of which are described above in Section I.

The process may include adjusting the pH of the ash tea by modifying a feed rate of the biomaterial. In some embodiments, increasing the biomaterial feed rate may increase the alkaline content of the ash tea due to the release of alkaline minerals present in the biomaterial, thereby increasing the pH of the ash tea. In some embodiments, decreasing the biomaterial feed rate may decrease the alkaline content of the ash tea due to the release of alkaline minerals present in the biomaterial, thereby decreasing the pH of the ash tea. Similarly, increasing the amount of time the burned biomaterial is steeped in the water may further increase the pH of the ash tea by the release of additional alkaline minerals. Similarly, decreasing the amount of time the burned biomaterial is steeped in the water may further decrease the pH of the ash tea by the release of fewer alkaline minerals.

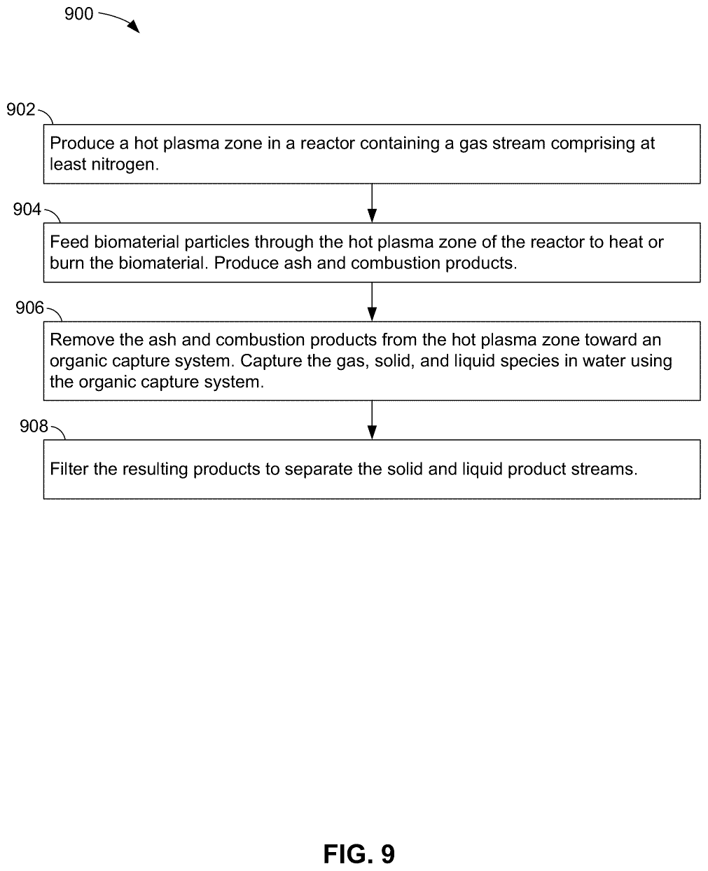

Turning now to the figures, FIG. 9 is a flowchart of a process 900 for producing ash tea. Step 902 includes producing a hot plasma zone in a reactor containing a gas stream comprising at least nitrogen. In many embodiments, this gas stream will also comprise oxygen. Step 904 includes feeding biomaterial particles through the hot plasma zone of the reactor to heat or burn the biomaterial. This produces ash and combustion products. Step 906 includes removing the ash and combustion products from the hot plasma zone toward an organic capture system and to capture the gas, solid, and liquid species in water using the organic capture system. Step 908 includes filtering the resulting products to separate the solid and liquid product streams.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Enumerated Embodiments

Embodiment 1: A plasma or high-temperature combustion system for producing ash tea, the system comprising:
a reactor including a combustion chamber, the combustion chamber comprising one or more gas inlets and one or more biomaterial inlets, the combustion chamber configured to burn nitrogen gas and a biomaterial to produce ash and combustion products;
an organic capture module operably connected to the plasma reactor to transport the ash and combustion products from the plasma reactor to the organic capture module, the organic capture module configured to capture the ash and combustion products in water, thereby generating ash tea.

Embodiment 2: The system of embodiment 1, wherein the combustion products comprise NO and NO₂ formed by the burning or fixation of nitrogen gas.

Embodiment 3: The system of embodiment 1 or 2, wherein the plasma or high temperature combustion reactor is a microwave-generated plasma reactor, an arc-based plasma reactor, or a radio frequency plasma reactor.

Embodiment 4: The system of any one of embodiments 1-3, further comprising a pump fluidly connected to each of the one or more gas inlets to pressurize the gas before entering the reactor.

Embodiment 5: The system of any one of embodiments 1-4, wherein the one or more gas inlets introduces a gas comprising nitrogen gas, oxygen gas, air, or any combination thereof into the reactor.

Embodiment 6: The system of any one of embodiments 1-5, wherein the biomaterial is a particulate.

Embodiment 7: The system of any one of embodiments 1-6, wherein the biomaterial comprises solid particulate smaller than 1000 microns.

Embodiment 8: The system of any one of embodiments 1-7, wherein the biomaterial comprises wood, sawdust, alfalfa, almond shells, almond husks, pistachio shells, nut shells, high-protein plant waste, corn steep liquor powder, dried corn husks, or any combination thereof.

Embodiment 9: The system of embodiment 1, wherein the biomaterial is a liquid, the system further comprises a pump fluidly connected to the reactor and to a spray nozzle.

Embodiment 10: The system of any one of embodiments 1-9, further comprising a Venturi-style pump, conveyor, screw feeder, vibratory trickler, rotary valve, or propeller operable to mechanically transport the biomaterial from a biomaterial reservoir to the one or more biomaterial inlets.

Embodiment 11: The system of any one of embodiments 1-10, wherein the organic capture module includes:
a solid organic capture submodule configured to steep the ash and combustion products in water to produce ash tea; and
a fluidic organic capture submodule configured to absorb the combustion products in water to produce ash tea.

Embodiment 12: The system of any one of embodiments 1-11, wherein the organic capture module includes a first organic capture module and a second organic capture module.

Embodiment 13: The system of any one of embodiments 1-12, wherein the organic capture module includes a tray column, water bubble dispersion column, or shower column.

Embodiment 14: The system of any one of embodiments 1-13, wherein the combustion products include oxidized nitrogen species (e.g., nitric oxide, nitrogen dioxide, etc.), nitrogen, oxygen, carbon dioxide, carbon monoxide, volatile organic compounds, smoke or very fine particles, bio-oils, water vapor, or any combination thereof.

Embodiment 15: The system of any one of embodiments 1-14, wherein the organic capture module includes an inlet fluidly connected to a pump to introduce water to the organic capture module.

Embodiment 16: The system of any one of embodiments 1-15, wherein the organic capture module includes a gas product outlet fluidly connected to a blower or fan to remove unabsorbed combustion products from the organic capture module.

Embodiment 17: The system of any one of embodiments 1-16, wherein the organic capture module includes an aqueous product outlet fluidly connected to a pump to remove ash tea from the organic capture module.

Embodiment 18: The system of any one of embodiments 1-17, further comprising an oxidation chamber in fluidly connected to the reactor and the organic capture module to oxidize the combustion products produced in the reactor.

Embodiment 19: The system of any one of embodiments 1-18, wherein the organic capture module further comprises a filter to separate the ash from the ash tea.

Embodiment 20: The system of any one of embodiments 1-19, wherein the organic capture module comprises a hot quench device configured to spray water onto the ash and combustion products.

Embodiment 21: The system of any one of embodiments 1-20, wherein the organic capture module includes a particulate filtration module.

Embodiment 22: The system of any one of embodiments 1-21, wherein the biomaterial is fed through an axial port in the reactor or into vortexing directional streams of gas flow in the reactor.

Embodiment 23: The system of any one of embodiments 1-22, wherein the combustion chamber is configured to burn nitrogen and oxygen.

Embodiment 24: The system of embodiment 23, wherein the nitrogen and oxygen are present in a volume ratio from 80:20 and 30:70.

Embodiment 25: A process for producing ash tea, the process comprising:
burning a biomaterial and nitrogen in a high temperature combustion reactor to form ash and combustion products;
and capturing and steeping ash and combustion products in water to form ash tea.

Embodiment 26: The process of embodiment 25, wherein the high temperature combustion reactor is a plasma reactor.

Embodiment 27: The process of embodiment 25 or 26, wherein the high temperature combustion reactor produces a hot zone having a temperature of greater than 1500° C.

Embodiment 28: The process of any one of embodiments 25-27, further comprising absorbing the combustion products in water.

Embodiment 29: The process of any one of embodiments 25-28, further comprising separating some or all of the combustion products from the ash prior to capturing and steeping in the water.

Embodiment 30: The process of any one of embodiments 25-29, further comprising separating the ash from the ash tea.

Embodiment 31: The process of any one of embodiments 25-30, further comprising cooling the combustion products to a temperature of about 40° C. or less before the absorbing step.

Embodiment 32: The process of any one of embodiments 25-31, wherein the combustion products include oxidized nitrogen species, nitrogen, oxygen, carbon dioxide, carbon monoxide, volatile organic compounds, smoke, bio-oils, water vapor, or any combination thereof.

Embodiment 33: The process of any one of embodiments 25-32, further comprising oxidizing the ash and the combustion products in an oxidizing chamber prior to capturing and steeping in water.

Embodiment 34: The process of any one of embodiments 25-33, further comprising reducing the particle size of the biomaterial prior to burning the biomaterial.

Embodiment 35: The process of any one of embodiments 25-34, wherein the biomaterial comprises wood, sawdust, alfalfa, almond shells, almond husks, pistachio shells, nut shells, high-protein plant waste, or a combination thereof.

Embodiment 36: The process of any one of embodiments 25-35, further comprising increasing the pH of the ash tea by modifying a feed rate of the biomaterial.

Embodiment 37: The process of any one of embodiments 25-36, further comprising increasing the pH of the ash tea by increasing a duration of the steeping step.

Embodiment 38: An ash tea composition formed by the process of any one of embodiments 25-37, having a nitrogen to carbon ratio of 1:5 or higher.

Embodiment 39: An ash tea composition made by the process of:
burning a biomaterial and nitrogen in a high temperature combustion reactor to form ash and combustion products;
and capturing and steeping ash and combustion products in water to form ash tea.

Embodiment 40: A composition comprising water, wherein the water includes absorbed combustion products from high temperature combustion of a biomaterial and nitrogen, and wherein the absorbed combustion products include nitrates, carbonates, volatile organic compounds, potassium, micronutrients, fats, proteins, or any combination thereof.

What is claimed:

1. A plasma or high-temperature combustion system for producing ash tea, the system comprising:
a reactor including a combustion chamber, the combustion chamber comprising one or more gas inlets and one or more biomaterial inlets, the combustion chamber configured to burn nitrogen gas and a biomaterial to produce ash and combustion products;
an organic capture module operably connected to the plasma reactor to transport the ash and combustion products from the plasma reactor to the organic capture module, the organic capture module configured to capture the ash and combustion products in water, thereby generating ash tea.

2. The system of claim 1, wherein the combustion products comprise NO and NO₂ formed by the burning or fixation of nitrogen gas.

3. The system of claim 1, wherein the plasma or high temperature combustion reactor is a microwave-generated plasma reactor, an arc-based plasma reactor, or a radio frequency plasma reactor.

4. The system of claim 1, further comprising a pump fluidly connected to each of the one or more gas inlets to pressurize the gas before entering the reactor.

5. The system of claim 1, wherein the one or more gas inlets introduces a gas comprising nitrogen gas, oxygen gas, air, or any combination thereof into the reactor.

6. The system of claim 1, wherein the biomaterial is a particulate.

7. The system of claim 1, wherein the biomaterial comprises solid particulate smaller than 1000 microns.

8. The system of claim 1, wherein the biomaterial comprises wood, sawdust, alfalfa, almond shells, almond husks, pistachio shells, nut shells, high-protein plant waste, corn steep liquor powder, dried corn husks, or any combination thereof.

9. The system of claim 1, wherein the biomaterial is a liquid, the system further comprises a pump fluidly connected to the reactor and to a spray nozzle.

10. The system of claim 1, further comprising a Venturi-style pump, conveyor, screw feeder, vibratory trickler, rotary valve, or propeller operable to mechanically transport the biomaterial from a biomaterial reservoir to the one or more biomaterial inlets.

11. The system of claim 1, wherein the organic capture module includes:
a solid organic capture submodule configured to steep the ash and combustion products in water to produce ash tea; and
a fluidic organic capture submodule configured to absorb the combustion products in water to produce ash tea.

12. The system of claim 1, wherein the organic capture module includes a first organic capture module and a second organic capture module.

13. The system of claim 1, wherein the organic capture module includes a tray column, water bubble dispersion column, or shower column.

14. The system of claim 1, wherein the combustion products include oxidized nitrogen species (e.g., nitric oxide, nitrogen dioxide, etc.), nitrogen, oxygen, carbon dioxide, carbon monoxide, volatile organic compounds, smoke or very fine particles, bio-oils, water vapor, or any combination thereof.

15. The system of claim 1, wherein the organic capture module includes an inlet fluidly connected to a pump to introduce water to the organic capture module.

16. The system of claim 1, wherein the organic capture module includes a gas product outlet fluidly connected to a blower or fan to remove unabsorbed combustion products from the organic capture module.

17. The system of claim 1, wherein the organic capture module includes an aqueous product outlet fluidly connected to a pump to remove ash tea from the organic capture module.

18. The system of claim 1, further comprising an oxidation chamber in fluidly connected to the reactor and the organic capture module to oxidize the combustion products produced in the reactor.

19. The system of claim 1, wherein the organic capture module further comprises a filter to separate the ash from the ash tea.

20. The system of claim 1, wherein the organic capture module comprises a hot quench device configured to spray water onto the ash and combustion products.

21. The system of claim 1, wherein the organic capture module includes a particulate filtration module.

22. The system of claim 1, wherein the biomaterial is fed through an axial port in the reactor or into vortexing directional streams of gas flow in the reactor.

23. The system of claim 1, wherein the combustion chamber is configured to burn nitrogen and oxygen.

24. The system of claim 23, wherein the nitrogen and oxygen are present in a volume ratio from 80:20 and 30:70.

25. A process for producing ash tea, the process comprising:
burning a biomaterial and nitrogen in a high temperature combustion reactor to form ash and combustion products;
and capturing and steeping ash and combustion products in water to form ash tea.

26. The process of claim 25, wherein the high temperature combustion reactor is a plasma reactor.

27. The process of claim 25, wherein the high temperature combustion reactor produces a hot zone having a temperature of greater than 1500° C.

28. The process of claim 25, further comprising absorbing the combustion products in water.

29. The process of claim 25, further comprising separating the ash from the ash tea.

30. An ash tea composition made by the process of:
burning a biomaterial and nitrogen in a high temperature combustion reactor to form ash and combustion products;
and capturing and steeping ash and combustion products in water to form ash tea.
